(19) United States
(12) Patent Application Publication
(10) Pub. No.: US 2008/0104246 A1
(43) Pub. Date: May 1, 2008

(54) Method and apparatus for tagging content data

(75) Inventors: Eyal Katz, Ramat-Gan (IL); Ofir Paz, Rishon-LeZion (IL)

Correspondence Address: Martin D. Moynihan;PRTSI, Inc., P.O. Box 16446, Arlington, VA, 22215, US

(73) Assignee: Hingi Ltd., Tel-Aviv (IL)

(21) Appl. No.: 11/589,848

(22) Filed: Oct. 31, 2006

(51) Int. Cl. G06F 15/16; G06F 15/173

(52) U.S. Cl. 709/226; 709/219

(57) ABSTRACT

An apparatus for tagging and provisioning user generated content in an intuitive-associative manner, comprising: a content item receiver, configured to receive at least one user generated content item from a first user, a content tag assigner, configured to assign at least one tag to at least one of the received content items, a data receiver, configured to receive data identifying a transmission source from a second user, a matcher, associated with the data receiver, configured to match at least one relevant item transmitted in the source at a time frame of the receiving with at least one of the content items, and a provisioner, associated with the matcher, for provisioning selected content items of the content items to the second user.

### FIELD AND BACKGROUND OF THE INVENTION

The present invention relates generally to a content tagging and provisioning apparatus and method. More particularly but not exclusively, the present invention relates to apparatus and a method for tagging content, and provisioning the content in an impulsive-associative manner. The present invention also relates to a way to associatively search and retrieve user generated and other content from such a system.

Sales through cellular networks and the Internet have become a booming market.

Strategy Analytics research groups estimate that by 2008 wireless subscribers will be spending over $11 Billion globally to download applications over cellular networks to mobile devices. Cellular Carriers project significant revenue growth from content delivery as an overall percentage of their wireless data revenues.

Ringtone (monotones and polytones) sales hit 3.2 billion US dollars in 2003 and are expected to reach 8.2 billion US dollars in 2008 (according to The ARC Group).

According to The Arc Group, the mobile entertainment content business (including games, ringtones, and other content) is expected to hit 27 billion US dollars by the end of 2008.

There are many known in the art methods and systems for provisioning contents over a cellular network or the Internet.

US Patent Application Publication No. 20030232616, entitled “Rule-based system and method for managing the provisioning of user applications on limited-resource and/or wireless devices” addresses various aspects of aggregation and management of contents.

US Patent Application Publication No. 20030154487, entitled “Digital content providing system” provides a technique to perform delivery and billing in a digital content providing system through a network.

However the current processes of searching and or purchasing through cellular networks or the Internet are rather cumbersome.

Currently, a user is expected to provide at least one piece of information related to the content he is interested in receiving: a performer's name, a song name, an album name, a ringtone catalog number etc. Typically the user also has to navigate through flexible multiple paged menus, which is a time-consuming and inconvenient user experience.

Furthermore many users are deterred by such a multiple paged menu-driven approach, lack patience for such a cumbersome process, or fail to recall the information related to the content they are interested in (such as the name of a performer or a song just played on the user's favorite radio station).

Reference is now made to FIG. 1 which is a flow chart illustrating an exemplary scenario for acquiring content according to the prior art.

In the exemplary prior art scenario, a user hears a song on the radio or watches a clip on TV 100. The user likes the song or clip and decides he wants to have the song/clip as a ringtone (monotone, polytones. etc.) on his cellular phone 120. The user has to give at least one piece of information specifically related to the ringtone he is interested in downloading: a performer name, a song name, a ringtone catalog number etc. 140, information which the user does not necessarily have and which may simply slip the mind of the user. Typically, for giving the information, the user also has to browse through multiple paged menus so as to provide the information related to the ringtone 160. Having found the ringtone at last 180, the user may now download the ringtone 190.

As illustrated with the above example, prior art does not provide with a truly impulsive-associative content purchasing method as the user must provide information which relates specifically to the content the user is interested in. Furthermore, current methods also fail to provide a way to tag content, in a manner which enables truly impulsive-associative content purchasing.

There is thus a widely recognized need for, and it would be highly advantageous to have an apparatus and method for impulsive-associative content provisioning which is devoid of the above limitations.

### SUMMARY OF THE INVENTION

According to one aspect of the present invention there is provided an apparatus for tagging and provisioning user generated content in an intuitive-associative manner, comprising: a content item receiver, configured to receive at least one user generated content item from a first user, a content tag assigner, configured to assign at least one tag to at least one of the received content items, a data receiver, configured to receive data identifying a transmission source from a second user, a matcher, associated with the data receiver, configured to match at least one relevant item transmitted in the source at a time frame of the receiving with at least one of the content items; and a provisioner, associated with the matcher, for provisioning selected content items of the content items to the second user.

According to a second aspect of the present invention there is provided an apparatus for tagging and provisioning content in an intuitive-associative manner.

The apparatus comprises a content item receiver, configured to receive at least one content item from a content provider, and a content tag assigner, configured to assign at least one tag to at least one of the received content items, the tags comprising a rating tag.

The apparatus further comprises a data receiver, for receiving data identifying a transmission source from a user, a matcher, associated with the data receiver, for matching at least one relevant item transmitted in the source at a time frame of the receiving with at least one of the content items, and a provisioner, associated with the matcher, for provisioning selected content items of the content items to the user.

The apparatus may further comprise an extractor, associated with the data receiver, for extracting an identity of the source from the data.

The source may be a broadcasting channel such as a TV station or a radio channel, a narrowcasting channel such an Internet Peer to Peer (P2P) data channel. etc.

Optionally, the matcher is further configured to use the tags for the matching.

Preferably, the provisioner is further configured to present the tags assigned to the selected content items to the user.

Optionally, the matcher is further configured to retrieve the relevant items from a list of items transmitted in the source over the time frame. The list of items may be dynamically assembled for each source by an assembler being a part of the apparatus.

Preferably, the assembler comprises: a source item reader, for reading an item being transmitted in the source, an item identifier, associated with the source item reader, for identifying the transmitted item, and a list updater, associated with the item identifier, for updating the list of items with identification data of the identified transmitted item and a respective time frame of transmission of the identified transmitted item.

The assembler may further comprise a statistics generator, configured to dynamically generate statistics relating to items transmitted in the source.

The item identifier may be further configured to use one of a group comprising: statistics relating to items transmitted in the source, general statistics relating to transmitted items, and statistics relating to preferences according to a geographic region of the source.

The apparatus of further comprise a content catalog builder, for building a content catalog, the content catalog builder comprising: an item receiver, for receiving a content item, an identification receiver, for receiving identification data of the content item, a fingerprint extractor, for extracting an identifying fingerprint from the content item, and a content updater, for updating the content catalog with the identifying fingerprint and with the identification data.

The content catalog builder may further include a remote content updater, operable for remotely updating the content catalog with an identifying fingerprint pointing to a remotely stored content item and for remotely updating the content catalog with identification data relating to a remotely stored content item.

The content updater may be further configured to update the content catalog with data pertaining to a location of the fingerprint within the content item.

Preferably, the provisioner is further configured to present the content items to the user in a dynamically configurable interactive graphical user interface (GUI).

The provisioner may be further configured to select at least one of the content items for provisioning to the user, according to at least one of a group comprised of: a predefined preference with respect to the content items, information relating to the user, information relating to content items, provisioning history data, capabilities of a receiving device used by the user, geographic data, demographic data, socio-economical data, and user made selections.

The extractor may be configured to utilize at least one of a group comprised of optical character recognition (OCR), image processing, and spelling correction, for extracting the identity of the source from the data received from the user. The apparatus may further comprise a history recorder, associated with the provisioner, configured to record history data relating to content provisioning to the user. The history recorder may be configured to record back-up data pertaining to the provisioned content items, for future use by the user.

The recorded back up data may comprise provisioned content items to be used by the user, say for allowing the user to download content items previously provisioned to him, say for downloading the items to a new handset the user uses.

The apparatus may also comprise a correlation data generator, associated with the provisioner, configured to generate correlation data pertaining to correlation between transmission of an item in a source and provisioning of a respective content item to a user. The correlation data may comprise at least one of a group comprising: user characterizing data, source data, time of provisioning, type of content item, geographic data, demographic data, socioeconomic data, or tags assigned to the content items, as described in further detail hereinbelow.

According to a third aspect of the present invention there is provided a method for tagging and provisioning content in an intuitive-associative manner.

The method comprise: receiving at least one content item from a content provider, and assigning at least one tag to at least one of the received content items, the tags comprising a rating tag.

The method further comprises: receiving data identifying a transmission source from a user, matching at least one relevant item transmitted in the source at a time frame of the receiving with at least one content item, and provisioning selected content items of the content items to the user.

Optionally, the matching is carried out using the tags.

Preferably, the method further comprises presenting the tags assigned to the selected content items to the user.

Optionally, the method further comprises extracting an identity of the source from the data.

According to a fourth aspect of the present invention there is provided an apparatus for provisioning tagged content in an intuitive-associative manner, comprising: a data receiver, for receiving a user message, a provisioner, associated with the data receiver, for provisioning a content item to a user, according to the user message and at least one tag, pre-assigned to the content item, a matcher, associated with the provisioner, for matching the provisioned content item with a relevant item from at least one item transmitted in a respective source, the matching being carried out according to a time frame of the user message and relevance of the transmitted item to the provisioned content item; and a correlation data generator, associated with the matcher, for generating data pertaining to correlation between the relevant item and the provisioned item.

Optionally, the apparatus is further configured to retrieve the relevant item from a list of items transmitted in the source.

The provisioner may be further configured to facilitate purchase of goods or services, utilizing the selected content items.

The provisioner may be further configured to facilitate gambling, utilizing the selected content items.

The provisioner may be further configured to facilitate multi party games through the Internet or the mobile operators, utilizing the selected content items.

According to a fifth aspect of the present invention there is provided an apparatus for finding rights in a content item, comprising: a content receiver, configured to receive the content item; a matcher, associated with the content receiver, configured to find a match between the content item and at least one catalogued item having predefined rights recorded in a catalogue; and a right enforcer, associated with the matcher, and configured to perform a predefined action upon finding the match.

According to a sixth aspect of the present invention there is provided an apparatus for finding a source according to a content item transmitted therein, the apparatus comprising: a content receiver, configured to receive the content item from a user; a matcher, associated with the content receiver, configured to match the content item with at least one transmitted item, wherein the transmitted item is transmitted in a source at within a time frame of the receiving the content item; and a data provider, associated with the matcher, and configured to provide the user with data pertaining to the source.

According to a seventh aspect of the present invention there is provided an apparatus for finding a source according to a content item transmitted therein, the apparatus comprising: a content attribute receiver, configured to receive a content attribute from a user; a matcher, associated with the content receiver, configured to match at least one content item with at least one relevant item, wherein the relevant item is transmitted in a source within a time frame of the receiving the content attribute, and the content item is pre-assigned an attribute similar to the content attribute; and a data provider, associated with the matcher, and configured to provide the user with data pertaining to the source.

According to an eighth aspect of the present invention there is provided an apparatus for tagging and provisioning content in an intuitive-associative manner, comprising: a content tag assigner, configured to assign at least one tag to at least one content item; a data receiver, configured to receive data identifying a transmission source from a user; a matcher, associated with the data receiver, configured to match at least one relevant item transmitted in the source at a time frame of the receiving with at least one of the content items; and a provisioner, associated with the matcher, for provisioning selected content items of the content items to the user.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow chart illustrating an exemplary scenario for acquiring content according to prior art.

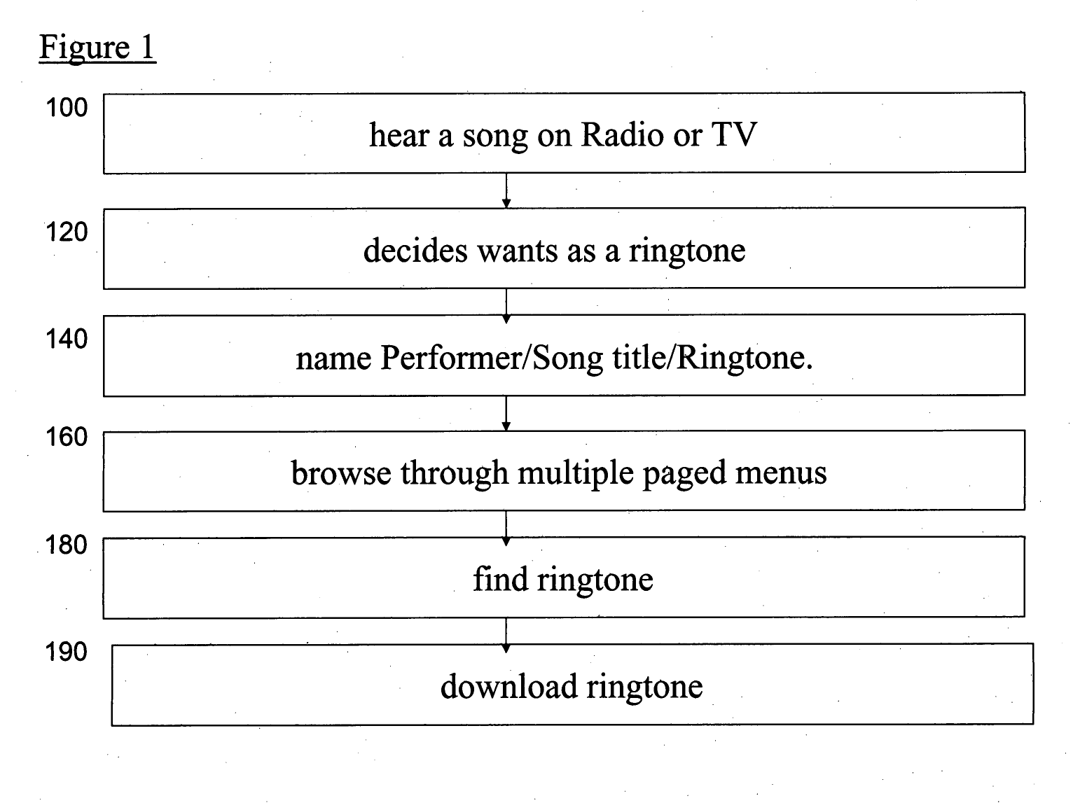

FIG. 2 is a flow chart illustrating an exemplary scenario for acquiring content according to a preferred embodiment of the present invention.

FIG. 3a is a block diagram of a first apparatus for tagging and provisioning user generated content in an intuitive-associative manner, according to a preferred embodiment of the present invention.

FIG. 3b is a block diagram of a second apparatus for tagging and provisioning content in an intuitive-associative manner, according to a preferred embodiment of the present invention.

FIG. 4 is a block diagram illustrating a content catalog builder according to a preferred embodiment of the present invention.

FIG. 5 shows an exemplary fingerprint database record according to a preferred embodiment of the present invention.

FIG. 6 is block diagram of a matching record generator according to a preferred embodiment of the present invention.

FIG. 7 is a block diagram illustrating a content generator according to a preferred embodiment of the present invention.

FIG. 8 is a block diagram illustrating an assembler according to a preferred embodiment of the present invention.

FIG. 9 shows an exemplary candidate item database record according to a preferred embodiment of the present invention.

FIG. 10 illustrates an exemplary multi-step GUI according to a preferred embodiment of the present invention.

FIG. 11 is a detailed block diagram of a third apparatus for tagging and provisioning content in an intuitive-associative manner, according to a preferred embodiment of the present invention.

FIG. 12 is a block diagram illustrating a fourth apparatus for tagging and provisioning content in an intuitive-associative manner, according to a preferred embodiment of the present invention.

FIG. 13a is a block diagram illustrating a first apparatus for people metering according to a preferred embodiment of the present invention.

FIG. 13b is a block diagram illustrating a second apparatus for people metering according to a preferred embodiment of the present invention.

FIG. 14 is a block diagram illustrating an apparatus for assembling a channel list of items (a channel play list), according to a preferred embodiment of the present invention.

FIG. 15 is flow chart illustrating a method for tagging and provisioning content in an intuitive-associative manner, according to a preferred embodiment of the present invention.

FIG. 16 is a flow chart illustrating an exemplary gambling scenario according to a preferred embodiment of the present invention.

FIG. 17 is a flow chart illustrating a billing method according to a preferred embodiment of the present invention.

FIG. 18 is a detailed flow chart illustrating a billing method according to a preferred embodiment of the present invention.

FIG. 19 is a block diagram illustrating an apparatus, for finding rights in a content item, according to a preferred embodiment of the present invention.

FIG. 20 is a block diagram illustrating an apparatus, for finding a source according to a content item transmitted therein, according to a preferred embodiment of the present invention.

FIG. 21 is a block diagram illustrating a second apparatus for finding a source according to a content item transmitted therein, according to a preferred embodiment of the present invention.

### DESCRIPTION OF THE PREFERRED EMBODIMENTS

The present embodiments comprise an apparatus and a method for provisioning content in an intuitive-associative manner. More specifically, the embodiment allows the generation of user generated content items and their provision to other users, in an associative-impulsive manner.

According to preferred embodiment of the present invention, user generated content items may be provided by the user. For example, a tourist may use the camera of a cellular handset to take a video clip of a Tsunami hitting a famous beach in Thailand. The clip is then received in real time, by a system as described hereinbelow.

The system assigns tags to the content item just provided by the tourist. The tags include the terms “Tsunami”, “News”, and “Thailand”.

Later on, another user, who watches a news report about the Tsunami in Thailand, may send an SMS bearing the word “News”.

Finally, the system provisions the user generated video clip to the user.

The principles and operation of an apparatus or a method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

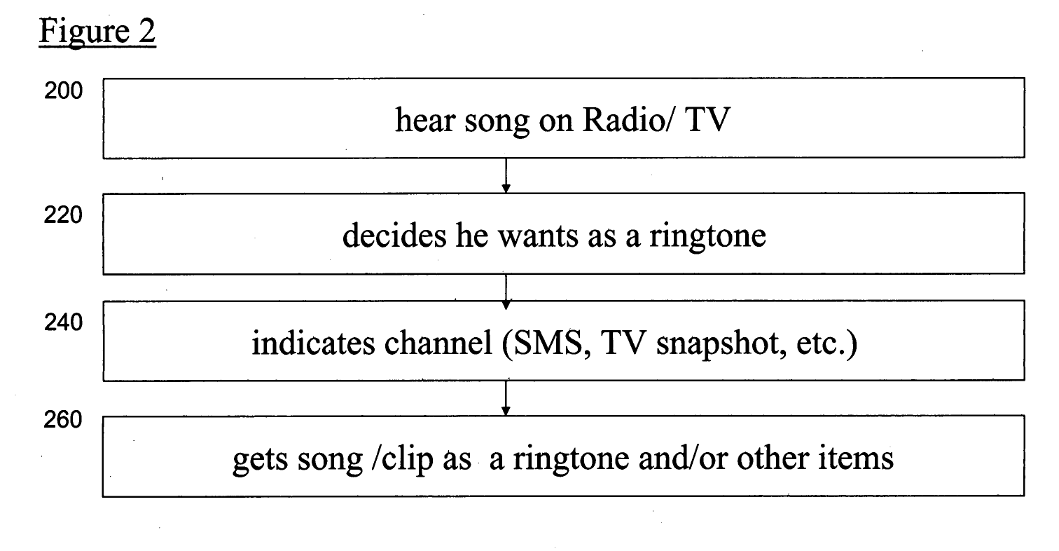

Reference is now made to FIG. 2 which is a flow chart illustrating an exemplary scenario for acquiring content according to a preferred embodiment of the present invention.

As illustrated in this exemplary scenario, according to a preferred embodiment of the present invention, a user hears a song on the radio or watches a clip on TV 200. The user likes the song or clip and decides he wants to have the song/clip as a ringtone (monotone, polytone, etc.) on his cellular phone 220.

The user does not have to know or recall any detail relating specifically to the song/clip. All the user has to do is to indicate the channel where the song or clip is transmitted 240. The user provides channel identifying data in one of possible formats including but not limited to: a textual format—such as an SMS cellular phone message (for example he sends the single word text message <MTV>) to a pre-assigned telephone number, or he uses the telephone's camera to provide the message in a visual format—such as a snap shot of the TV screen where the channel logo may be found. Knowing which items are transmitted in the channel in the time frame when the user inputs the channel identifying data, the desired ringtone may be automatically located and the user may get the clip he watches as a ringtone 260.

Optionally, the user is also offered other ringtones (or other content items) 260.

Some of the ringtone may be associated with tags, assigned to the content items, as described in further detail hereinbelow.

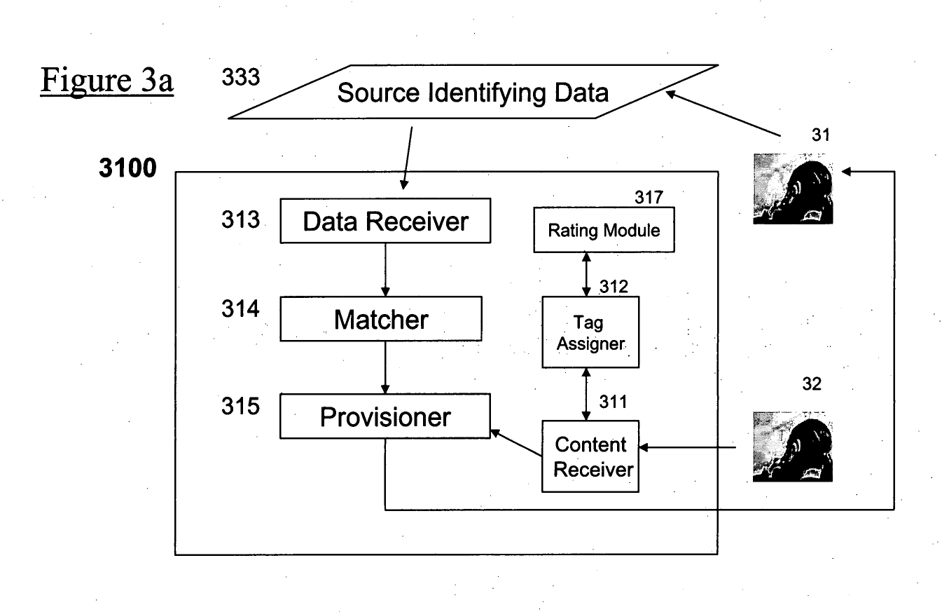

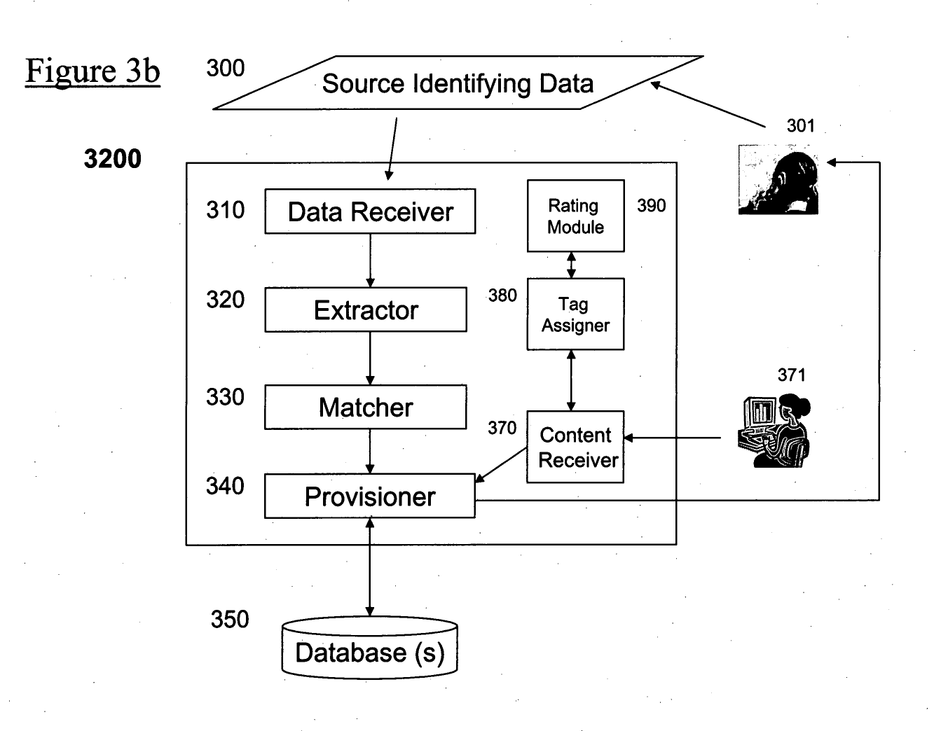

Reference is now made to FIG. 3a which is a block diagram of a first apparatus for tagging and provisioning user generated content in an intuitive-associative manner, according to a preferred embodiment of the present invention.

Apparatus 3100 includes a content item receiver 311, for receiving one or more user generated content items from a first user 31, as described in further detail in respect of FIG. 3b.

Apparatus 3100 further includes a content tag assigner 312, connected to the content item receiver 311.

The content tag assigner 312 assigns one or more tags to the received content item(s). Preferably, the assigning is carried out in a dynamic manner, as described in further detail hereinbelow. The tags may include a rating tag, a tag classifying a content item as erotic, a pricing tag, etc, as described in further detail in respect of FIG. 3b.

Preferably, apparatus 3100 further includes a rating module 317, connected to the content tag assigner 312.

The rating module 317 generates rating data. The rating data may pertain to the item—say according to the provisioning history of the content item (i.e the number of times each content item is provisioned to users), to the content item's provider, etc.

For example, the rating module 317 may generate rating for a content provider, based on the averaged rating of the content provided by the content provider.

The rating module 317 may also generate a user rating for a user. The user rating serves to rate the user according to rating data previously provided by the user, according to the number of content items previously provisioned to the user, etc.

Preferably, the content tag assigner 312 assigns the user a rating tag, based on the rating data generated by the rating module 317, as described in further detail hereinbelow.

Apparatus 3100 also includes a data receiver 313.

The data receiver receives from a second user 32, data identifying a transmission source 333, as describe in further detail hereinbelow.

Apparatus 3100 also includes a matcher unit 314, connected to the data receiver 313.

The matcher unit 314 matches one or more relevant item(s), transmitted in the source within the same time frame of the receiving, with one or more of the received content items as described in further detail hereinbelow, using FIG. 3b.

The apparatus 3100 also includes a provisioner 315, connected to the matcher 314, for provisioning selected content items (user generated video clips, etc) to the second user 32, as described in further detail hereinbelow.

Reference is now made to FIG. 3b which is a block diagram of a first apparatus for tagging and provisioning content in an intuitive-associative manner, according to a preferred embodiment of the present invention.

The apparatus 3200, according to a preferred embodiment, is preferably located at or in association with a content provider, who may provide content items such as video clips, ringtones, etc.

Apparatus 3200 also includes a data receiver 310, for receiving data 300 which identifies a source from a user 301 (say a certain TV station). The data 300 may be received via a network which may for example be the telephone network, the cellular network or the Internet.

The source may be, but is not limited to, a broadcasting channel such as a TV channel or a radio channel, a narrowcasting channel such a video on demand (VOD) channel or an Internet P2P (peer to peer) data channel, or any other source.

According to a preferred embodiment, the data receiver 310 may be attached to a connector which facilitates communication with the user 301. The connector may link the apparatus 3200 to an external network such as a cellular network, the Internet, a cable network, a satellite network, a wireless network, any other communication media, or a combination thereof.

The connecter may be configured to handle various aspects of the communication between the apparatus 3200 and the external network such as a cellular network, a satellite network, a wireless network, etc.

The user 301 may input the source identifying data using a communication device, including but not limited to a mobile phone, a personal digital assist (PDA), a PC, a TV set-top box, a gaming console, an Internet messenger (such as a messenger provided by Yahoo™, AOL Instant Messenger™, or MSN™), a VoIP telephone or Video software (such as Skype™), or any other known in the art communication device.

Optionally, the apparatus 3200 may further include a source extractor 320, connected to the data receiver 310, for extracting an identifier of the source from the identifying data. The data source may be a music channel such as MTV. The user may identify the source by sending as an identifier the term “MTV”.

The identifying data may be textual data, for example—an SMS textual message.

Optionally, the source extractor 320 may use a spelling check/correction or any other known in the art text processing tool, in order to extract the identifier of the source from the textual data, in case the user has incorrectly typed it in. For example, Fix may be corrected to Fox (Fox TV).

In addition a thesaurus like functionality may also be used by the source extractor 320, thus enabling the source extractor 320 to extract the source identifier according to any synonymous identifier for the source that may be found in the source identifying data. The thesaurus-like functionality would include alternative names used to describe particular sources.

The identifying data may be non-textual. For example—a snap shot of a clip broadcast on MTV. The extractor 320 may be configured to use image processing tools for locating and interpreting the MTV logo (identifier) in the snap shot.

The source extractor 320 may employ other known in the art techniques as well. For example, the source extractor may utilize optical character recognition (OCR) when extracting the source identifier from a hand written message identifying the source which the user inputs using a PDA for example.

The apparatus 3200 may also include a matcher 330, for matching relevant items being transmitted in the source at a time frame of the user input data with one or more provisionable content item(s).

Optionally, one or more relevant item(s) are retrieved from a list of items that are transmitted in the source (a play list of the source), according to a time frame of the receiving of data identifying the source. The matcher 330 then matches the relevant items with one or more content item(s).

Preferably, the matched content items have an associative relationship with the relevant transmitted item(s). The matched content items may also include sponsored content item(s), etc.

The apparatus 3200 also includes a provisioner 340, connected to the matcher, for provisioning selected content items of the matched content items to the user 301.

The provisioner 340 may select the content item(s) for provisioning to the user 301 according to one or more of the following criteria (or according to any other predefined criteria): a predefined preference with respect to the content items (for example, a preference for content items that are provided by a certain content provider), information relating to the user (such as gender, age, occupation, etc.), information relating to content items, provisioning history data (general or specific to the user), capabilities of a receiving device used by the user 301, geographic data, demographic data, socio-economical data, and selections made by the user 301 (say by a graphical user interface as described in greater detail hereinbelow).

Optionally, the provisioner 340 may be configured to provision selected content items to the user 301, even if the message received from the user 301 is an empty one or if the source extractor 320 fails to extract a source identifier from the message, based on the above described criteria, applied to available content items.

For example, in the case of an empty message, the provisioner 340 may be configured to send the user 301 a currently most popular content item. Such a most popular item may be selected using such criteria as the item provisioned to the greatest number of users, or users in the same region, or at the time frame when the user sends his empty message.

Alternatively, the apparatus 3200 may be configured to return an error message to the user 301 when an empty message is received from the user or when the source extractor 320 fails to extract a source identifier from the message.

Preferably, the apparatus also includes a format converter that may be connected to the provisioner 340. The format converter may be used for converting a content item, to be provisioned to the user 301, into a format which is compatible with a type of a content receiving device which is used by the user 301 (a specific type of a mobile phone, a specific palm pilot model, etc.).

In a preferred embodiment of the present invention, the selected content items may be provisioned to the user 301 by the provisioner 340, as web links.

For example, the provisioner 340 may provision the content items as web links to be made available to the user 301 using a web browser, say Microsoft™ Internet Explorer. For example, upon receiving a message bearing the term “MTV” from the user 301, a list of suitable web links is presented to the user 301.

Optionally, a content item may be provisioned as a link usable for downloading a stream of a live radio broadcast, a live television broadcast, etc.

Optionally, a content item may be provisioned as a message informing the user 301 about a future event. For example, when the user 301 watches a Sport Magazine on a certain TV Channel, the user 301 may be sent a message informing the user about a Basketball match, scheduled to be broadcasted in another channel, at a later hour.

Optionally, the matcher 330 may utilize information retrieved from the web using a search engine such as Google™.

Thus the matcher receives an impulsive text message from the user 301 and uses it in a web search using the aforementioned search engine. The user 301 is then sent a list of web sites relating to a performer of the clip just played on say MTV™.

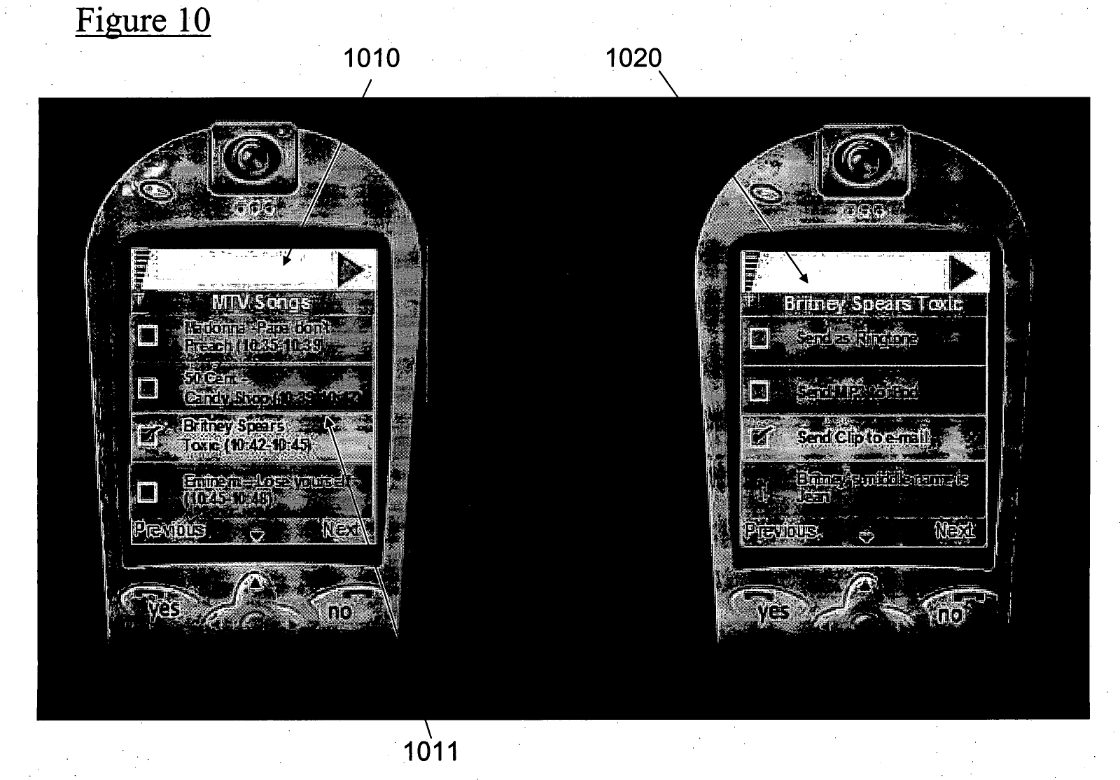

Optionally, the provisioned content items may be presented to the user 301 using an interactive and multiple layered interface. For example, using the multiple layered interface, as illustrated and explained hereinbelow using FIG. 10, the user 301 may be asked multiple choice questions about his preferences (say with regards to Pop music vs. Classical music), the format he wishes to receive content items in, etc.

The multiple step process may be dynamically managed by a GUI manager, as described hereinbelow.

A content item may also be provisioned to the user 301 in a single step scenario. For example, an SMS text message bearing “MTV” may be input, and a Beatles monotone may be sent to the user cellular unit as a response, since at the time, MTV™ happens to be broadcasting a Beatles clip.

Optionally, the provisioner 340 may be configured to verify that the user 301 is authorized to receive the selected content items. Such verification is preferably carried out prior to provisioning to the user 301, say by a security management utility, such as any of the known in the art security systems or user authorization management systems.

Preferably, the provisioner 340 verifies the ability of the user 301 to receive the selected content items, based on predefined criteria.

The predefined criteria may involve but are not limited to technical data, financial (say using a billing module as described hereinbelow) data, operative data, or any other data. The data may be recorded in a dedicated database 350 of user profiles, connected to the provisioner 340.

According to a preferred embodiment of the present invention, the provisioner 340 may also comprise a DRM (Digital Rights Management) module which may be employed for guaranteeing that all royalties are paid to owners of copyrights in the provisioned content items.

According to a preferred embodiment of the present invention, apparatus 3200 includes a content receiver 370, for receiving one or more content items from a content provider 371.

Preferably, the content items are received over a network such as a cellular network, the Internet, etc. For example, a cellular handset installed with a camera, may be used by the handset's user, for taking the picture of a live event, and sending the picture to the apparatus 3200, say for selling the picture to news agencies. Similarly, a user may offer any other User Generated Content Items for sale, through the apparatus 3200.

Optionally, the one or more of the content items is received through a client agent installed at premises of the content provider. For example, a content provider, who provides content items on a regular basis, may choose to install an API client agent on his personal computer. The API client agent may be used by the content provider to send several content items to the apparatus 1000 together.

In one example, the content provider 371 may be a remote user of the apparatus 3200. The content provider 371 wishes to offer a content item, perhaps generated by the content provider 371 himself, through the apparatus 3200. The content item may for example be an amateur video clip shot by the content provider 371, and the content provider may wish to sell it or provide it for free.

According to a preferred embodiment, the apparatus 3200 also includes a content tag assigner 380, connected to the content receiver 370.

The content tag assigner 380 assigns one or more tags to a received content item, as described in further detail hereinbelow.

Optionally, the content tag assigner 380 may use data pertaining to real time events. For example, a video clip of a goal, scored in a live broadcast Soccer Match, may be dynamically and automatically tagged, in accordance with the details of the live broadcast match, the exact time when the goal is scored, etc.

The tag may be a rating tag for the item. Optionally, the rating tag may be based on rating data generated by a rating module 390 connected to the tag assigner 380, as described hereinabove.

The rating tag may indicate the rating of the item—say according to the provisioning history of the content item, the rating of the content item's provider, etc. Preferably, the content tag assigner 380 assigns the rating tag to the content items just before the content item is provisioned to the user. Consequently, the rating tag may be based on up-to-date rating data.

Optionally, the rating tag is based on rating data provided by an operator of the apparatus 3200. The operator may also provide data for tagging the item, for classifying the content item (say, as erotic, as educational, etc). The operator may also provide data for tagging the content item with respect to the item's price to the user 301, the item's cost (charged by the provider of the content item), or any other property, as known in the art.

Preferably, the provisioner 340 prompts the user 301 to rate a content item provisioned to the user 301, and the content tag assigner 380 uses the rating provided by the user 301, for assigning the rating tag to the content item. Optionally, if the rating provided by the user is low, the user is offered a refund for the content item.

For example, the user may be a cellular handset user, who is provisioned with ringtones. The user may be prompted to provide a rating for a ringtone, just after the user finishes downloading the ringtone. The rating may be obtained using a cellular GUI (Graphical User Interface) which has been specifically tailored for receiving a rating through the user's handset from the user. The user may also provide the rating using SMS (Short Message Service), through a cellular WAP connection, or through any other known in the art method.

In another example, the user of a cellular phone may be allowed to provide a delayed rating for a content item, hours or days after the item is provisioned to the user. The delayed rating may be provided through a WAP, SMS, an Internet web site, etc.

More preferably, the matcher unit 340 further uses historic data pertaining to the user's previous ratings, for other content items. The historic data is used for normalizing the rating provided by the user for the content item, in light of the user's rating pattern as evident from the user's historic data. For example, a relatively high rating provided by a user, whose average rating is high, may be normalized into a lower rating, and vise versa.

Preferably, the matcher 330 uses the tags for matching the relevant content items.

For example, certain content items may be tagged with a tag indicating a time limit for their provisioning, say for limiting the provisioning of Christmas gifts to a period the two weeks before Christmas, limiting the provisioning of certain content items according to an hour limit (say 11 PM-5 AM, for erotic content items, or to an hour when a certain. TV program is broadcast, or to the channel name where a certain TV program is broadcast), etc. Consequently, the matcher 330 does not match content items tagged as Christmas gifts after Christmas, matches content items tagged with an hour limit only in accordance with the hour limit, matches content items associatively related to a certain TV program when the program is broadcast, etc.

In another example, certain items are tagged with tags indicating time and source, say BBC and 10 AM-11 AM, when a certain Funny Video program is broadcast on BBC. Consequently, the matcher 330 may match content items, which have an associative relation to the program broadcast at this hour on BBC, say a user generated funny video clip.

The tag may include one or more data fields, including but limited to: time, data, weekday, month, genre (say Jazz music), song name, performer name, geographical region, channel (say MTV), program name (say “Saturday Night Live”), language, a search keyword, price to the user, price charged by the content provider, etc.

Preferably, apparatus 3200 further includes an event manager, connected with the tag assigner 380 and the matcher 330.

The event manager may be used to define events, such as a goal scored in a Soccer Match. The defined event may be user as a tag assigned to relevant content items.

For example, a Soccer video clip may be assigned a Goal tag. When a goal is scored, the defined event is raised (say by an operator of the apparatus 3200). Consequently, the matcher unit 330 matches the content item assigned the Goal tag with the item transmitted in the source, and the content item is provisioned to the user, as described in further detail hereinbelow.

Preferably, the provisioner 340 presents content items provisioned to the user 301 with one or more of the tags assigned to each content item.

More preferably, the provisioner 340 presents the content items to the user 301, through a dynamically configurable GUI. For example, the GUI may be configured to present the content items, in an order determined according to the tags assigned to each of the content items.

For example, when a user watches a Madonna clip on MTV, and sends data identifying the MTV Television Channel, the user may be presented Madonna video clips content items, as well as Madonna's Sex Book (released in 1992). In accordance with a policy predefined by a user of the apparatus 3200, the clips may be presented in a first page, in an order determined according to a price tag assigned to each of the clip items. The book may be presented in a second page, etc.

Preferably, the apparatus 3200 further includes a content blocker, connected to a database storing content items, or to the provisioner 340. The content item may be used by an operator of the apparatus 3200, for blocking a content item. Consequently, the provisioner 340 avoids provisioning the blocked content item to the user 301.

Preferably, the apparatus 3200 further includes a management unit, connected to the content item receiver 370. The management unit may be used to edit the received content item, reject the received content item (say for content deemed not appropriate by the operator of the apparatus), examine the content item, change the format of the content item, etc.

Optionally, the management unit also finds content items having a rating (as indicated by a tag assigned to the item, by the rating module 390, etc) lower than a predefined reference value. The found items may be forwarded to an operator of the apparatus 3200, for examination.

Optionally, the operator may choose to block the found items, say using the content blocker, as described in further detail hereinabove. Preferably, the item found to have a rating lower than the predefined reference value is automatically blocked by the content blocker.

According to a preferred embodiment of the present invention, the apparatus 3200 may also include an assembler which may be connected to the matcher 330.

The assembler may be configured to dynamically assemble a list of items (a source play list) transmitted by a particular transmission source. Preferably, the list of items is a real time updated list of items transmitted in a given source with their respective transmission time frames.

In a preferred embodiment, the assembler includes an item reader, configured to read an item which is being transmitted in the source and an item identifier, for identifying the transmitted item (as described hereinbelow).

The assembler further includes a list updater, for adding identification data of the transmitted item to the list of items transmitted in the source (the source play list), together with a time frame when the item is transmitted in the source.

According to a preferred embodiment of the present invention, the item identifier may utilize a fingerprint comparison for identifying the transmitted item.

A fingerprint of an item is a condensed form of the item. The condensed form comprises the results from some kind of analysis and summary of the content of the item. For example, the content item may be a song, and the fingerprint may be a chorus of the song.

Preferably, a comparison is made by the item identifier with identifying fingerprints residing in a content catalog where each identifying fingerprint is associated with a related content item.

Thus, the assembler extracts a fingerprint from the transmitted item, using known in the art techniques, and compares the fingerprint with the identifying fingerprints in the content catalog. The comparison may also include using data pertaining to a location of the compared fingerprints within each of the compared items. The resulting identification is used to automatically build the playlist.

According to a preferred embodiment, the item identifier carries out the identifying of the item transmitted in the source using statistics relating to the items transmitted in the source, statistics relating to items transmitted in general, statistics relating to preferences in a geographic region of the source, etc.

According to a preferred embodiment of the present invention, the assembler may also include a statistics generator, configured to generate and collect statistics relating to the items transmitted in the source. For example, the statistics generator may generate a list of the ten most popular items in a specific source by some measure, or the ten most frequently played items of the source.

In a preferred embodiment of the present invention, the assembler is configured to treat time gaps between two items that are consecutively transmitted in the source in a variety of ways.

For example, the gap may be skipped (say when the gap consists of talks between two songs). In another example, a commercial may be added to the assembled list of items (to be linked with content items such as a ringtone of the song played in the commercial or a site where the product offered in the commercial is sold.)

According to a preferred embodiment, the apparatus 3200 may also include a content catalog builder.

The content catalog builder is used for building the content catalog discussed hereinabove.

In a preferred embodiment of the present invention, the content catalog builder includes an item receiver, for receiving a content item such as a video clip or a song, and an identification receiver, for receiving identification data relating to the content item such as a name of a song, a name of a performer, a name of an album, a show name, etc.

The content catalog builder further includes a fingerprint extractor, for extracting an identifying fingerprint from the content item, as described in greater detail hereinbelow, and a content updater for updating the content catalog with the identifying fingerprint and with the identification data relating to the identifying fingerprint. Preferably, the content updater may also update the content catalog with data pertaining to a location of the fingerprint within the content item.

The apparatus 3200 may also include a history generator, connected to the provisioner 340, for recording history relating to provisioning of content items to the user.

The following paragraphs provide a detailed description of components of the above discussed apparatus.

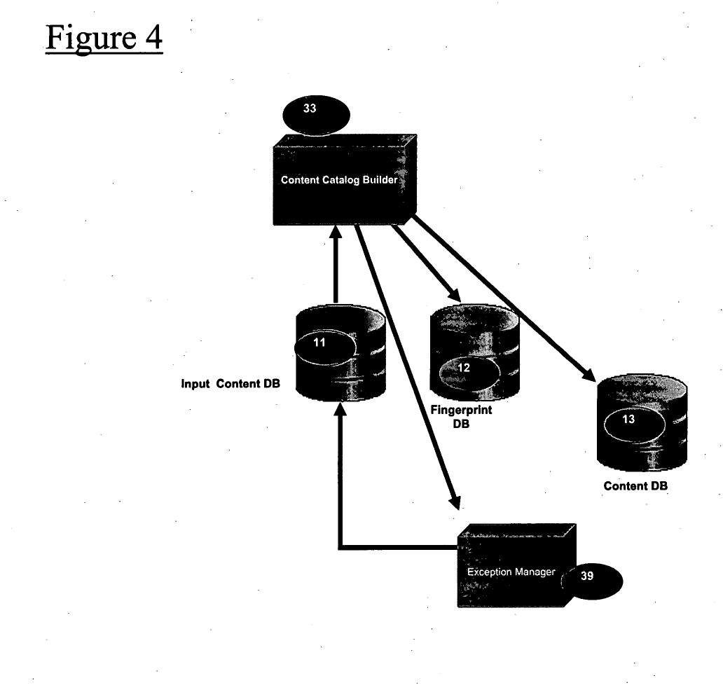

Reference is now made to FIG. 4 which is a block diagram illustrating a content catalog builder according to a preferred embodiment of the present invention.

According to a preferred embodiment of the present invention, the content catalog comprises a fingerprint database 12 and a content database 13.

In a preferred embodiment, the content catalog builder main module 33 inputs a content item from an input content database 11, the content catalog in its turn may be populated with content items from a variety of origins, including but not limited to: external Internet content providers, music albums, broadcast video clips etc.

Optionally, a remote user such as a cellular mobile unit user may also be a content provider. The content items provided by the user may be tagged, say by the content tag assigner 320, as described in further detail hereinabove.

In a preferred embodiment the content catalog builder further includes an exception manager 39.

Optionally, a content item is provided together with identification data pertaining thereto. The identification data may include, but is not limited to, details such as a song name, an album name, a performer name, a TV show, etc.

Alternatively, the content item may be provided without such identification data, in which case the exception manager 39 may prompt an operator of the apparatus 3200 to manually provide identification data for the content item.

Optionally, the content item may prompt the user for providing additional identification data to the content item, even if the content item is provided with identification data pertaining thereto.

According to a preferred embodiment, the content catalog builder is configured to extract an identifying fingerprint from the content item and to update the fingerprint database 12 with the identifying fingerprint, the content item identification data may be added to the content database 13, with its identifying fingerprint. Optionally, the content item itself may also be stored by the apparatus 3200, say in a local content item database.

There are many known in the art methods for extracting a fingerprint from a content item. According to some of the known in the art techniques, a fingerprint consists of 32 bits which are extracted from a sub block of the content item.

A fingerprint may be generated for every sub block of the content item. As a fingerprint is a significantly smaller piece of data than the usually high quality content item, the fingerprint database may be loaded with a relatively large number of fingerprints, and may be used for an accurate and fast identification of transmitted items, as described in greater detail hereinbelow.

In a preferred embodiment, the fingerprint may be further shortened, say from 32 bits to 28 bits, by any known in the art techniques, say by retaining the first most significant bits.

In a preferred embodiment, the fingerprint database may include an immense number of fingerprint records and be divided into a number of files.

According to preferred embodiment, the fingerprints may be treated as integer numbers, sorted, and divided between the files according to their numerical value. For example, a non shortened 32 bit fingerprint may be treated as a 32 bit integer number. With this embodiment, each file holds a consecutive range of these numbers, and the total number of files covers the whole range of possible values.

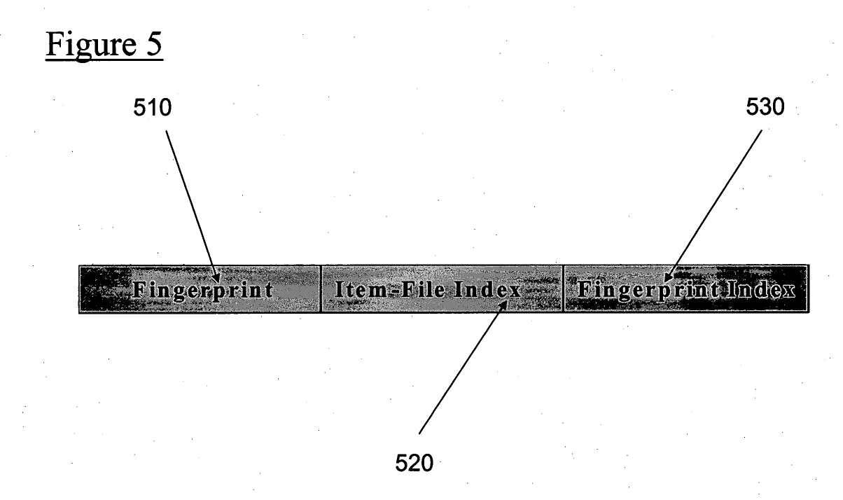

Reference is now made to FIG. 5, which shows an exemplary fingerprint database record according to a preferred embodiment of the present invention.

According to a preferred embodiment, each file contains all the fingerprints that fall within its range. Each fingerprint record comprises the fingerprint 510 associated with an item-file index 520 and a fingerprint index 530.

The fingerprints in the file are ordered so as to enable quick search through the fingerprint database.

The item file index 520 is a unique identifier given to any content item input the system. This number is unique for any recording or version of the item. For example, each of two different performances of the same song, one from a studio recording and the other from a live recording, is assigned a different item-file index 520.

The fingerprint index 530 indicates the position of the fingerprint within the content item. That is to say, the position of the sub block the fingerprint belongs to, relative to the beginning of the content item.

This index 530 may be used together with the fingerprint 510, for identifying a source transmitted item, by the assembler, when dynamically assembling the list of items (play list) for the source, as discussed in greater detail hereinabove.

The content database 13 record may list identifiers and descriptors for the specific content item. The identifiers and descriptors may contain (in addition to the unique item-file index 520), but is not limited to: the name of a performer, the name of a song, the name of an album, the name of a TV show, and other relevant information pertaining to the content item.

The content database 13 is sorted according to the song file index, for fast retrieval of information in the real time system. Preferably, the content database 13 is also indexed according to a performer name, a show name, etc.

In a preferred embodiment, a content item may be provided by a content provider who chooses to retain the content item within his private premises.

In such a case, the content catalog builder may be implemented in a distributed manner. The content provider may be provided with the means for extracting a fingerprint from a content item according to a standard which is defined for the apparatus 3200.

Thus with this embodiment, the identifying fingerprint extraction phase is carried out by a module of the content catalog builder which is implemented at the content provider.

Preferably, the content catalog builder further includes a remote content updater that may be included in a module provided to a content provider. The remote content updater may be operated for remotely updating the content catalog with an identifying fingerprint pointing to a remotely stored content item, retained in the premises of a content provider, with identification details of the remotely stored content item, etc.

The resultant fingerprint and identification data relating to the content item are used by centrally implemented modules of the content catalog builder, handling the updating of the catalog databases as described hereinabove.

According to a preferred embodiment of the present invention, identifying fingerprints for different types of content items (such as audio, video, or any other type) may be used for identifying transmitted items, say by the assembler.

According to a preferred embodiment of the present invention, the content catalog builder further implements an initial step for verifying that the input content item does not already exist in the database. Preferably, the initial step may be based on existing fingerprints in the catalog, their related identification data, or both.

As described hereinabove, the matcher 330 according to a preferred embodiment of the present invention is configured to retrieve one or more relevant item(s) from an updated list of items transmitted in the source (a play list of the source).

Optionally, the relevant items are retrieved by the matcher 330 according to a time frame when the source identifying data is inputted such as a time stamp associated with a user sent message carrying the source identifying data. Optionally, the time stamp may be corrected, so as to eliminate network latency and user reaction time interferences.

The matcher 330 is also configured to match the relevant items with one or more content item(s).

Preferably, the matched content items may have an associative relationship with the relevant transmitted item(s). The matched content items may also include sponsored content item(s).

The matcher 330 may be configured to match the relevant source transmitted items with contents items such as songs, video clips, sport clips, news clips, ringtones etc.

The matching of content items may be carried out utilizing a predetermined set of rules. An exemplary rule may define that if Madonna's “Like a virgin” is played on the source, any Madonna clip may be matched, while an alternative rule may define that only a “Like a virgin” Madonna clip may be matched.

Preferably, the matcher 330 is a dynamic component, bearing a capacity to match the relevant transmitted item(s) with content items included in a constantly growing number of available content items.

According to a preferred embodiment, the matcher 330 retrieves each of the relevant transmitted items from the list of transmitted items pertaining to the source (the source play list), and fetches corresponding matching data records that match the item to respective content items. Optionally, these matching data records may reside on the content catalog, discussed hereinabove.

Each of the matching data records may point to matching content items that are centrally stored in a content item catalog, in a centralized architecture, as described hereinbelow.

The matching data record may also point to a content item residing in the premises of a content provider, in a distributed architecture, as described hereinbelow.

According to a preferred embodiment of the present invention, the matching may also be carried out on the fly, without using the above discussed matching data record(s), searching for matched content items for the relevant transmitted content items ad hock, per a user input/request.

In a preferred embodiment, the matcher 330 may also communicate with affiliate content providers, in real time, for receiving from the affiliate content providers matching content items, thus implementing a fully decentralized architecture.

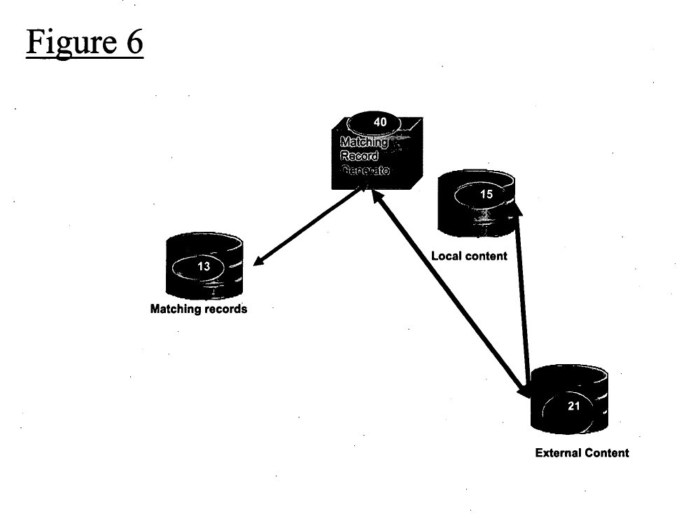

Reference is now made to FIG. 6 which is block diagram of a matching record generator according to a preferred embodiment of the present invention.

According to a preferred embodiment, the apparatus 3200 may include a matching record generator 40, for generating the matching record(s), discussed hereinabove.

A preferred embodiment of the present invention may implement a centralized architecture. In the centralized architecture all content items are centrally stored in one location.

In this case, the matching record generator 40 is fed with new content items that are stored centrally, and goes through relevant identifiers and descriptors of the new items for finding matches between each of the new content items and other content items. Preferably, the descriptors include the tags assigned to content items, say by the content tag assigner 380, as described in further detail hereinabove.

For example, a match may be found between two content items having the same performer or the same song name. The match found is recorded as a matching record 13 that may be used as described hereinabove. Optionally, the matching records reside in a content catalog, as described hereinabove. The matching records 13 point to centrally stored content items 15.

The type of content may also be noted. Content items may also be indirectly related, a special relevance marker may accordingly be included in the matching record. For example, a partial match between two content items, resulting from statistical data indicating that people who buy the one very often buy the other may also be recorded.

A preferred embodiment of the present invention may implement a distributed architecture. In this embodiment, a matching record 13 may point to a centrally stored content item.

However, in this preferred embodiment, a matching record 13 may also point to a content item which is stored in premises of an external content provider 21. Thus with the distributed architecture, some of the content items may be retained by external content provider(s) in their own databases 21.

Each of the content providers may install a module that provides identifiers/descriptors relating to a content item.

The matching record generator 40 generates one or more matching data records linking the content item to other content items. Each matching data record may also include an identifier of an affiliate content provider.

As described hereinabove, a preferred embodiment of the present invention may implement a fully distributed architecture.

With a fully distributed architecture, the matching is carried out on the fly, as described hereinabove, and no matching data record is needed in advance.

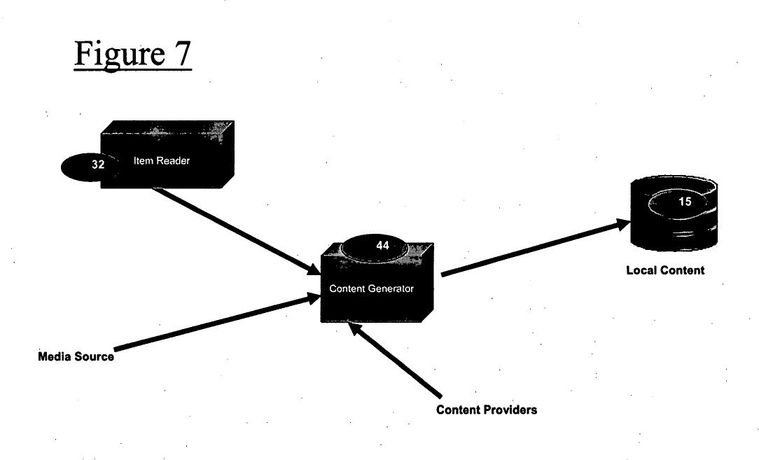

Reference is now made to FIG. 7 which is a block diagram illustrating a content generator according to a preferred embodiment of the present invention.

In a preferred embodiment of the present invention, the apparatus 3200 may further include a content generator, for automatically generating a new content item (such as a ringtone—monotone/polytone/etc.) from an existing content item or from selected parts of an exiting content item.

Optionally, the content generator may be used for automatically generating snipped versions of existing content items. The snipped versions may be converted to any one of a variety of content formats, including but not limited to ringtones (monotones, polytones, etc.), video clips, etc.

For example, the content generator may be capable of identifying chorus parts in a full song track and for automatically converting the chorus parts into ringtones. The content generator may identify the chorus by detecting fingerprint correlation among different blocks of the same song. Preferably, the content generator may further process the resultant ringtone so as to generate a polyphonic ringtone (Polytone).

In another example, the content generator may receive streamed video and audio of a live soccer match, identify a goal by detecting audience applause, and automatically generate a short video content item of the goal.

The content generator may detect the audience applause by finding fingerprint correlation among a sequence of blocks that differ from blocks that precede or follow the sequence. Preferably, the content generator employs decision logic for detecting interesting parts like a chorus, a goal, etc.

In a preferred embodiment, the generated content items are immediately fingerprinted and added to the content catalog by the content catalog builder, as described in greater detail hereinabove.

The content generator may be fed by an item reader 32, which reads items being transmitted in a source such as a broadcasting channel, content provided by external content providers, a media source such as a compact disc, or any other content source.

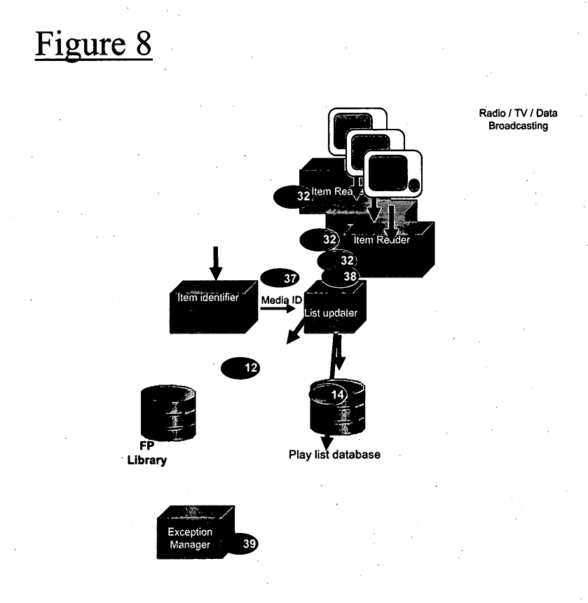

Reference is now made to FIG. 8 which is a block diagram illustrating an assembler according to a preferred embodiment of the present invention.

As described hereinabove, in a preferred embodiment of the present invention, the apparatus 3200 includes an assembler, for dynamically assembling the list of items transmitted in the source.

Preferably, the assembling includes reading an item as the item is being transmitted in the source, be it a broadcasting channel such as a TV channel or a radio channel, a narrowcasting channel such as a video on demand (VOD) channel or a P2P data channel, or any other source.

The assembler identifies the item, and adds identification data of the identified transmitted item and a time frame of transmission of the identified transmitted item to a list of items pertaining to the source (a source play list).

Preferably, the assembler may also dynamically generate statistics relating to transmitted items in the source(s). For example, the assembler may provide a list of most frequently played items per a specific source.

The assembler may be connected to several sources, in order to generate a specific list of items (play list) for each of the sources, in real time.

An exemplary assembler may include, according to a preferred embodiment of the present invention, an item reader (32), connected to a sampled source, for reading items transmitted in the source.

The assembler further includes an item identifier (37), fed with the read items, which may be locally or remotely connected to the item reader.

The item identifier (37) generates fingerprints from the fed items as described hereinabove for the content catalog builder.

Preferably, the content identifier (37) may also have access to the fingerprint database of the content catalog (12). The item identifier (37) compares fingerprints of the transmitted item (audio/video/other) to those of identifying fingerprints in the fingerprint database of the content catalog (12), and a preliminary list of candidate content items is generated.

The candidate list includes a list of identical fingerprints, associated with candidate content items, for each sub-block of the transmitted item. Each fingerprint in the list is represented in a candidate database where each record corresponds to one of the identical fingerprints in the list.

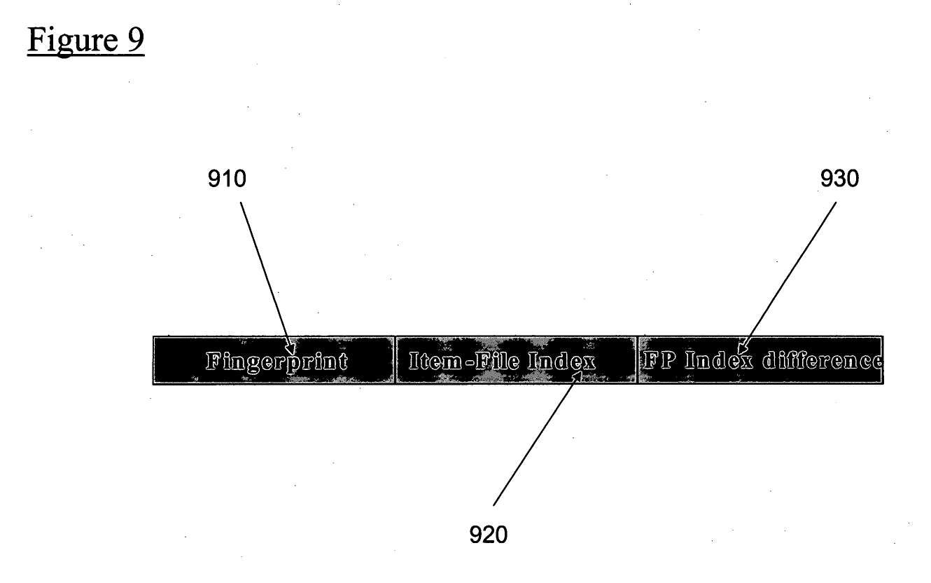

The record consists of three portions, as shown in FIG. 9: The fingerprint 910, the item-file index 920, and a fingerprint index difference 930. The finger print index difference indicates the difference in block location between the transmitted item and a candidate content item.

The item identifier (37) may include a decision rule engine.

The candidate database records may be transferred together with occurrence counters to the decision rule engine. Each of the occurrence counters indicates the number of fingerprints found for each candidate. That is to say, each occurrence counter gives the number of candidate records having the same item-file index 920.

The item identifier may use statistical data pertaining to available relevant statistics and other data.

The statistical data includes but is not limited to one or more of the following:

most frequently played items in the specific source,

statistics relating to history data pertaining to transmitted items in the source according to the day of the week and the hour,

music preferences according to a geographic region (language, type of music, etc.),

a predefined source play list, statistics and data relating to general popularity of songs or performers,

type of content characteristic of the source (say, video clips for MTV), and

music genre typical of the source.

For example, when a classical music channel list is being extracted, if two content items are identified as relevant, one being Vivaldi and another one being Madonna, the Vivaldi content item is more likely to be the item which is transmitted in the classical music channel and is thus the one identified by the item identifier (37).

According to a preferred embodiment, the assembler may use one or more known in the art algorithms for identifying the read item. More preferably, the assembler may include an artificial intelligence tool, as known in the art, for assisting in identification of the items being transmitted over the source and assembling of the list of items (play list) for each source. For example, a voice recognition algorithm may be employed to extract repeated lines from a chorus in a song and choose a name for the song based on the repeated lines.

The assembler further includes a play list creator 38, for creating and storing play list database records of the identified transmitted items, for each source, in a play list database 14.

As described hereinabove, the apparatus 3200 according to a preferred embodiment of the present invention may further include a connector, functioning as a gateway between the apparatus parts and external networks such as a cellular network, an IP (Internet protocol) network, a telephone network, and a private network, on which the user is located. The connector may use SMS, WAP, push WAP, MMS, E-Mails, IP, DTMF, etc.

The connector is aware of the system events that require generation of notification or sending of information to the subscriber. For each of the events the connector operates the delivery logic of that event. The delivery logic depends on both the specific event and the specific subscriber delivery rules.

The connector may further employ the format converter, described hereinabove, for converting a content item into a format usable by a receiving device used by the user.

According to a preferred embodiment of the present invention, the connector is a part of the provisioner 340, described hereinabove.

According to a preferred embodiment, the provisioner 340 may further include a graphical user interface (GUI) manager.

The GUI manager may dynamically design interactive graphical user interfaces, customized dynamically according to user specific parameters, user usage history, content item type, the identified source, inserted advertisements, location of the user—say to insert location specific data into the GUI pages as presented to the user by the provisioner, type of a device which the user uses, etc.

Preferably, the GUI is dynamically configurable, in real time, for each user, taking in consideration attributes of a specific device used by the user, such as a screen type, audio capabilities, internal memory of the device, etc.

According to a preferred embodiment, the GUI manager introduces other considerations into the GUI dynamic design process.

The GUI manager may present the selected content items to the user in an order which is set according to commercial considerations. For example, a certain priority may be granted to content items of a certain content provider, so that these items are presented first. In another example, saleable content items that are more profitable are presented first.

The GUI manager may present the provisioned content items to the user in an interactive graphical user interface that may include one or more pages. With the interactive graphical user interface, the user may interact with the apparatus 3200 for providing information relating to the preferences of the user with regards to types of content items, format of the content items, etc.

The user may be exposed to advertisements, business partner links, and the like, that may be inserted into GUI pages presented to the user during the interaction with the apparatus 3200.

Reference is now made to FIG. 10 which illustrates an exemplary multi-step GUI according to a preferred embodiment of the present invention.

The specific exemplary GUI includes a first dynamic page 1010 presenting a list of content items to the user. The most likely content the user is believed to be interested in is highlighted 1011 (Britney Spears—Toxic) and set as default. Upon receiving the user answer, a second page 1020 is presented to the user where the user may specify in what format and way he wishes to receive the content item (a clip which is sent by e-mail in this example).

Preferably, the content items are presented to the user through a dynamically configurable GUI. Optionally, the GUI may be configured to present the content items in an order determined according to the tags assigned to one or more of the content items, as described in further detail hereinabove.

According to a preferred embodiment of the present invention, the apparatus 3200 includes a history recorder, associated with the provisioner 340, for recording history relating to content provisioning to the user. The recorded history may serve to generate various statistics relating to content provisioning, as well as to generate rating data, as described in greater detail below.

Optionally, the statistics may be used for assigning tags to content items, as described in further detail hereinabove.

The recorded history may further serve as a back-up for the user, thus providing a stickiness service, meaning a service in which the provisioned content items stick with the user.

For example, a user who is registered as a subscriber of the apparatus may use a history record, saved for him by the history recorder, to re-download content items which were provisioned to the user in the past.

In a further example, a registered user who buys an MP3 song and receives it to his cellular phone, say as a monotone, may be able to receive this content item to a new cellular device he buys without having to purchase the item again.

According to a preferred embodiment, the history recorder may also be used for producing statistics relating to content purchasing patterns by users, for example—which content items are purchased, by whom, in what format, induced by which clip, or advertisement, and in which source was the clip or advertisement transmitted. The point is described in greater detail hereinbelow.

Preferably, the history recorder updates a user profile and behavior database, described hereinbelow. The user profile and behavior database stores user profiles and subscription data, predefined by an operator of the apparatus 3200 together with provision history, billing data, etc.

The profile and behavior database may be used for improving the user experience and for predicting which content items the user is more likely to be interested in.

Preferably, the apparatus may further include a statistically based logic, employed for predicting which item the user is likely to be interested in next, based on historic data generated by the history recorder. Details of the item are then forward to the GUI manager for insertion into the GUI page(s) presented to the user.

According to a preferred embodiment, the apparatus may further include a billing module which may be connected to the provisioner 340, and which implements a billing policy to be determined by an operator of the apparatus 3200 or his business partners. Preferably, the billing module may be connected to a DRM (Digital Rights Management), for guaranteeing copyright owners royalties, as described in greater detail hereinbelow.

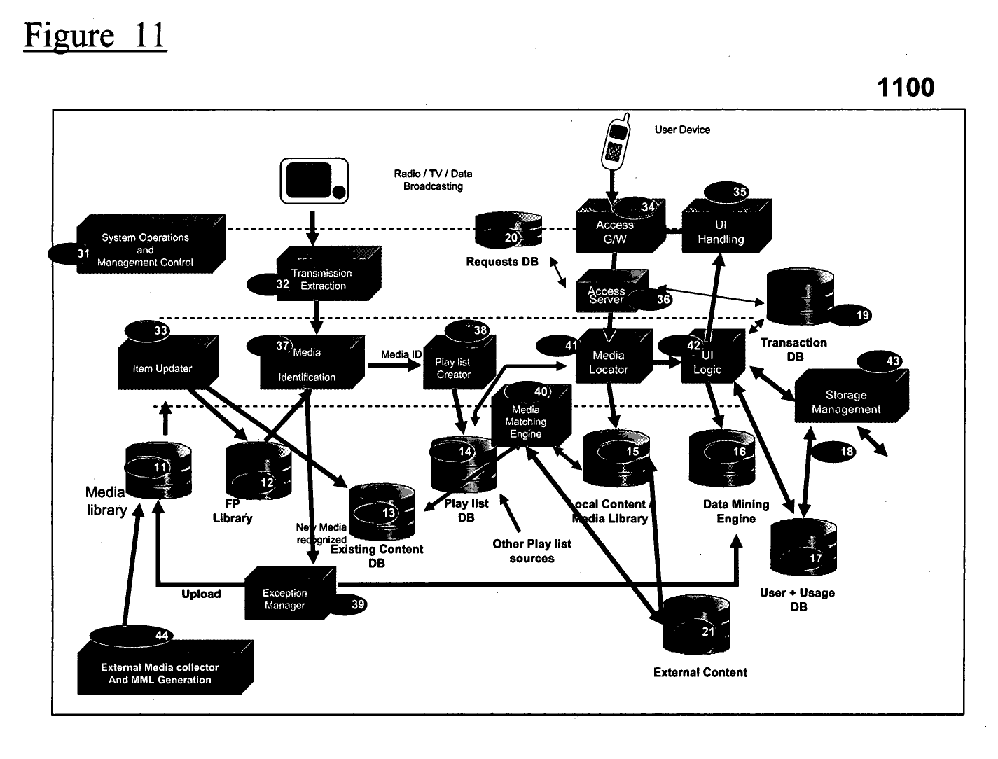

Reference is now made to FIG. 11 which is a detailed block diagram of a third apparatus for tagging and provisioning content in an intuitive-associative manner, according to a preferred embodiment of the present invention.

An alternative or additional apparatus 1100 according to a preferred embodiment of the present invention includes a system operations/management control unit 31 for monitoring and managing the apparatus 1100.

The apparatus further includes a transmission extraction unit 32 for extracting items from a TV/Radio/Data or other channel, a media identification unit 37 for identifying channel extracted items (automatically using a fingerprint library 12 or manually using an exception manager 39 for user identification of items, as described in detail hereinabove), and a play list creator 38 for generating a play list for each channel and storing the list in a dedicated play list database 14 while saving the content item itself in an existing content database 13.

Preferably, the content item is assigned one or more tags, say for rating the content item, as described in further detail hereinabove. The content item may be saved together with the tag(s) assigned to the content item, in the existing content database 13.

The existing content database 13 is fed by a media catalog engine 40 which process items residing in a local content/media library 15 as well as in external content databases 21, and by the play list creator 38 (thus adding content as well as updating the channel play list).

The existing content database 13 is also updated by the item updater 33 which reads items to be fingerprinted and stored from an input media library 11. The library is fed by external media collectors 44 that may be operated by an external content provider and by the exception manager 39. The exception manager 39 is used when a user needs to provide missing details identifying a content item. The item updater 33 updates the fingerprint library 12 and the existing content database 13.

The apparatus 1100 further includes several units that are employed for communicating with a user that is induced to impulsively buy content items, say by a clip on a TV channel that the user watches, as described hereinabove.

The apparatus units that are employed for communicating with the user, include, but are not limited to: an access gateway 34—connecting the apparatus 1100 to other networks, a user request database 20—for storing user requests, a user interface handling unit 35, an access server 36 which translates user requests into transactions, a transaction database 19, a user interface logic 42, a media locator for inserting selected media items to the pages presented to the user while provisioning selected relevant items to the user, and a user management database 17—for storing user profiles and history data pertaining to provisioning of content items to the use.

The apparatus 1100 may further include a storage management utility 43—for managing the various databases employed by the apparatus 1100, and a data mining engine 16 for generating various statistics, as described in greater detail hereinabove.

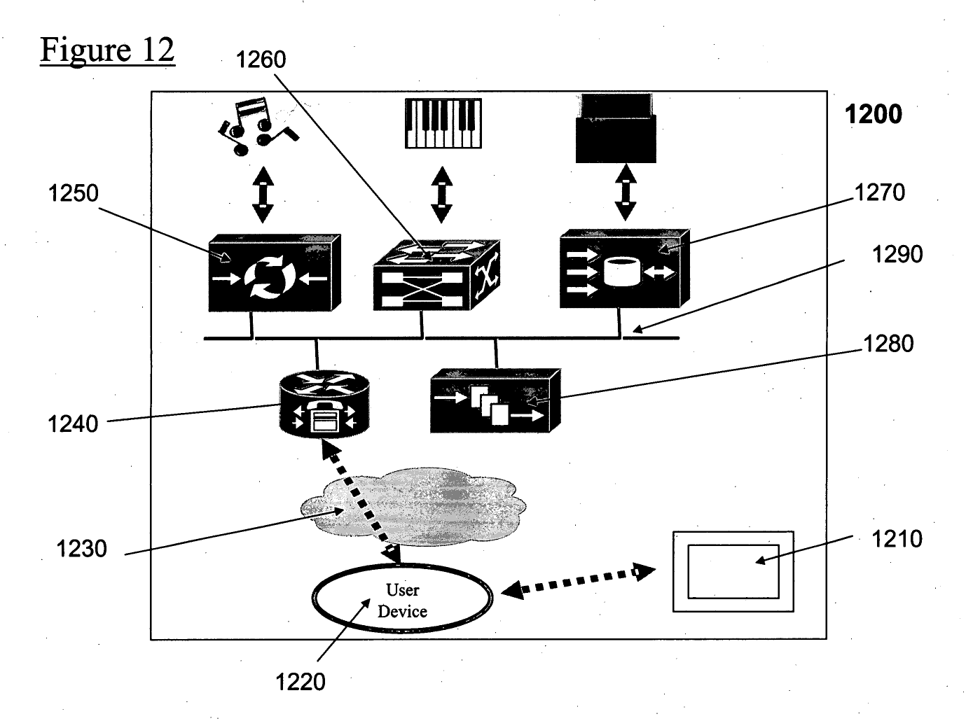

Reference is now made to FIG. 12 which is a block diagram illustrating a third apparatus for tagging and provisioning content in an intuitive-associative manner, according to a preferred embodiment of the present invention.

The apparatus 1200 according to a preferred embodiment of the present invention comprises dedicated servers (1240-1280), connected in a wired network 1290, each server implementing one or more part(s) of the apparatus 1200.

The apparatus 1200 communicates with a user device 1220 which is connected to an external network 1230. The external network 1230 may include, but is not limited to, any one way or two way communication system, such as a cellular system, e.g. GSM, GPRS, Edge, TDMA, CDMA to WCDMA, PHS, FOMA, from a first generation network to advanced generations like a second, a third, or a fourth generation cellular system, fixed line telephony, cable TV network, wired and wireless Internet, infrared, RF, etc.

The communication is carried out by the apparatus 1200 utilizing a data receiver 1240 which comprises a connecter that is used as a gateway, connecting the wired network 1290 to the external network 1230.

The connecter handles various aspects of communication between the apparatus 1200 and the external network 1230, as described in greater detail hereinabove.

The data receiver 1240 inputs the user sent message which comprises an identifier of the source 1210 inducing the impulsive purchase of a content item by the user, as described hereinabove.

The apparatus 1200 also includes a content item generator 1250 which is used to generate one or more new content items from an existing content item, as described hereinabove. For example, the content generator may be employed to generate a new ringtone (monotone/polytone) and a cellular clip from an input Madonna clip.

The apparatus 1200 further comprises a source play list (source list of items) assembler 1270, for assembling a real time play list of each source, utilizing internal and external data, as described in greater detail hereinabove.

The apparatus also include a matcher 1260, as described hereinabove. The matcher 1260 is configured to retrieve relevant items being transmitted in the source from the channel specific play list. The matcher 1260 then matches the relevant items with content items. Optionally, the matcher 1260 uses tags assigned to potentially relevant content items, for retrieving the relevant items among the potentially relevant content items, as described in further detail hereinabove.

The apparatus 1200 also includes a provisioner 1280 which is used to provision selected items of the matched content items to the user, optionally employing a GUI manager as described in greater detail hereinabove.

People Meter

In a preferred embodiment of the present invention, a people meter is introduced.

A people meter is a device for measuring how many people listen, or are exposed to, to radio, TV, cable, etc, and to which stations their radios or TVs are tuned.

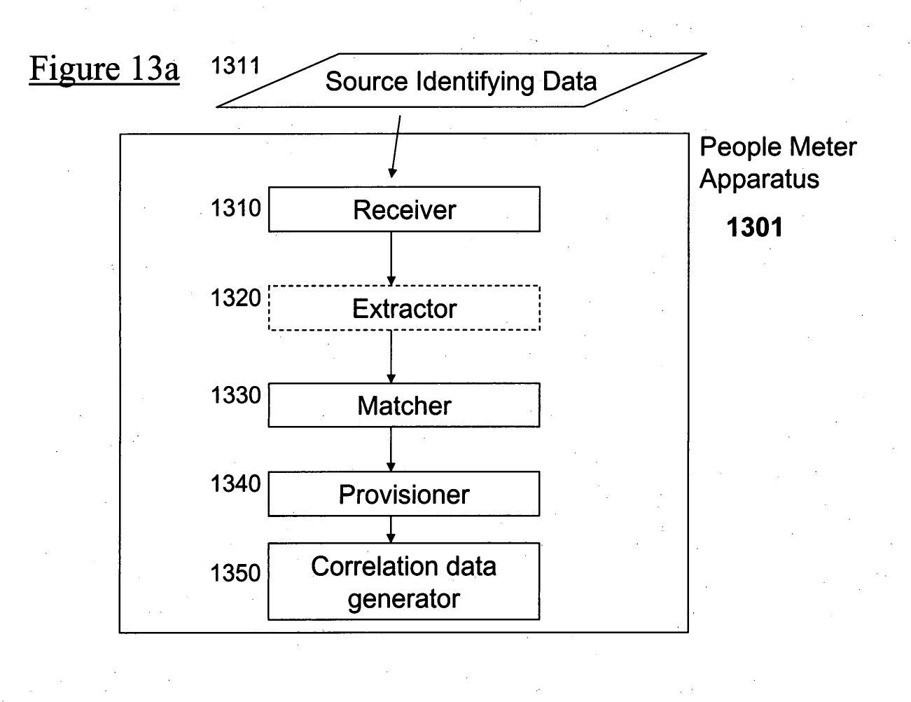

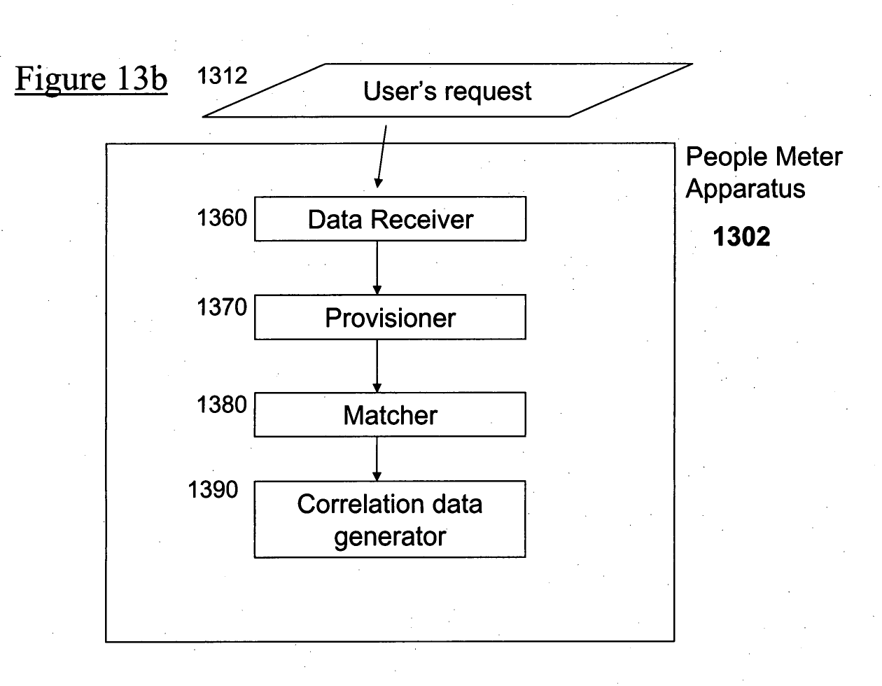

An apparatus according to a preferred embodiment of the present invention, as described using FIG. 13a hereinbelow, may have in its databases, data that may include, but is not limited to:
1. Who is the user, or the group of users
2. What channel the user watches/listens to (according to the input user, message, e.g. SMS)
3. At what time the purchase happens (since the system is a real time system)
4. What show/advertisement/etc. is transmitted in the channel at a time frame when the user sends his message (the show being retrieved from an internally generated or externally provided play list, from a program guide, or from another source)
5. What content the user buys or requests (since we give the user a link for the content data or content itself)
6. What type of content has the user bought in the past (using the recorded history data relating to content item provisioned to the user)
7. Geographical, demographic, or socioeconomic data.

For example, an apparatus for people metering as described hereinbelow and illustrated using FIG. 13A, has a capacity to provide correlation data statistic information that indicates what percentage of the users actually buy content, while listening to which TV show or being exposed to what promotion, in which channel, at what time, what content items are bought, geographic/demographic/socio-economic profile of the users who actually buy, etc.

That is to say, an apparatus for people metering as described hereinbelow and illustrated using FIG. 13A indicates how effectively the specific promotion/show induces the purchase of items by a user, based on gathered data that directly links the specific channel transmitted item and the provisioned items, actually purchased by a user.

Reference is now made to FIG. 13a which is a block diagram illustrating a first apparatus for people metering according to a preferred embodiment of the present invention.

An apparatus 1301 according to a preferred embodiment includes a data receiver 1310, for receiving source identifying data 1311 from a user.

The apparatus 1301 may further include a source extractor 1320, connected to the data receiver 1310, for extracting an identifier of the source from the input source identifying data 1311.

The apparatus 1301 also comprises a matcher 1330, for matching relevant items being transmitted in the source when the user sends the data with content items.

Optionally, the matcher 1330 automatically retrieves one or more relevant item(s) from an updated list of items transmitted in the source (source play list), according to a time frame of the receiving of the identifying data. The matcher 1330 may then automatically match the relevant items with at least one content item.

The apparatus also includes a provisioner 1340, for provisioning selected content items to the user.

For example, as a user watches a Soccer Match being broadcast on a TV sport channel, a commercial is played. The user is induced to buy a content item promoted in the commercial. The user sends his request and, and the content item is sold to the user.

The apparatus according to a preferred embodiment further includes a correlation data generator 1350, connected with the provisioner 1340, for generating people meter correlation statistics, as described hereinabove, thus providing a people metering utility. For example, the data generator 1350 may generate statistics indicating a correlation between a commercial broadcast on a certain TV channel and provisioning of a content item promoted in the commercial.

Reference is now made to FIG. 13b which is a block diagram illustrating a second apparatus for people metering according to a preferred embodiment of the present invention.

An apparatus 1302 according to a preferred embodiment of the present invention may include a data receiver 1360 which is used to retrieve a user sent request 1312 for a content item to be provisioned to the user and a provisioner 1370, for provisioning the requested content item to the user.

The apparatus 1302 further comprises a matcher 1380 which is used to match the provisioned content item to relevant items transmitted in a source. The source may be but is not limited to a broadcasting channel such as a TV station or a radio channel, an Internet P2P channel, etc.

Optionally, the matcher 1380 is configured to read the relevant items from one or more list(s), each list comprising items transmitted in a respective source, according to a time frame of the request made by the user.

By this matching, the matcher 1380 uncovers a linkage between the request of the user and a transmitted item that may be the inducer of the request, say a commercial or a show the user watches on a TV channel.

The apparatus 1302 further includes a correlation data generator 1390, for generating people meter correlation statistics, utilizing the above described matching, uncovering a linkage between a specific channel/show/commercial and an impulsive request to purchase the advertised product.

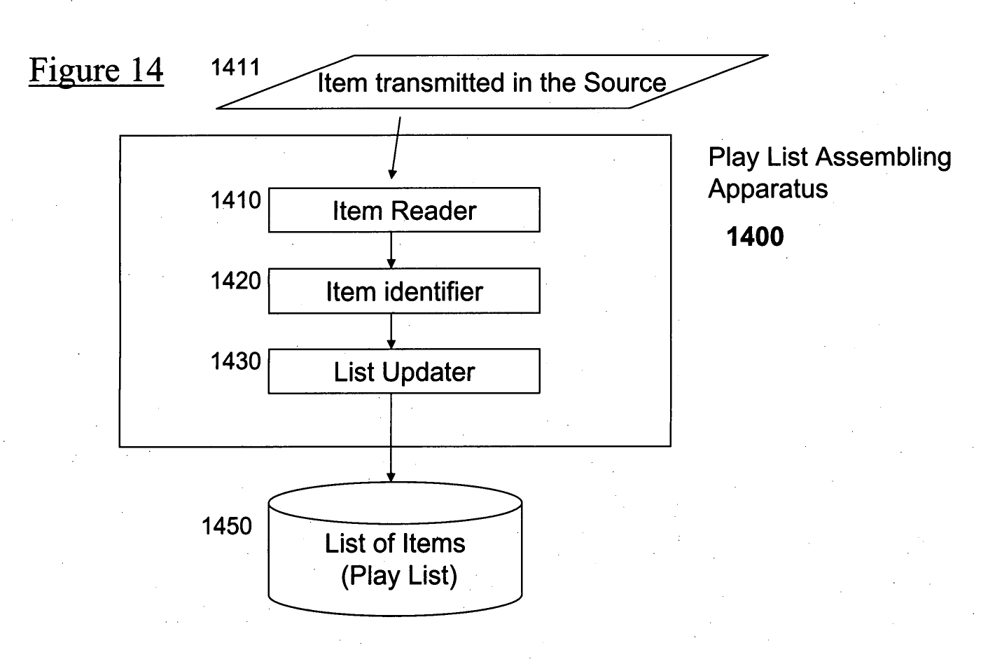

Reference is now made to FIG. 14 which is a block diagram illustrating an apparatus for assembling a source list of items (a channel play list), according to a preferred embodiment of the present invention.

The apparatus 1400 comprises a source item reader 1410, for reading an item being transmitted in the source 1411.

The apparatus 1400 also includes an item identifier 1420, connected to the source item reader 1410.

The item identifier 1420 is configured to identify the read item transmitted in the source. The item identifier 1420 may employ any of the above described methods for identifying the transmitted item. The item identifier 1420 may also employ any other method which is known in the art, for identifying the source transmitted item.

The apparatus 1200 may further comprise a list updater 1430, connected to the item identifier 1420, for adding identifying data of the transmitted item into a source list of items (a channel play list) 1450.

In one example, the apparatus 1400 may be used by a copyright organization such as Israel's Acum (www.acum.org.il) which is a non-profit corporation administering copyrights assigned to its members—authors, composers, lyricists, poets, and music publishers.

With the apparatus 1400, Acum may track the broadcasting of content items on the growing number of broadcasting channels (TV, Radio, Internet radio sites, etc.) for billing the channel operators for broadcasting content items that are owned by Acum members, so as to enable collection of royalties for the members of Acum.

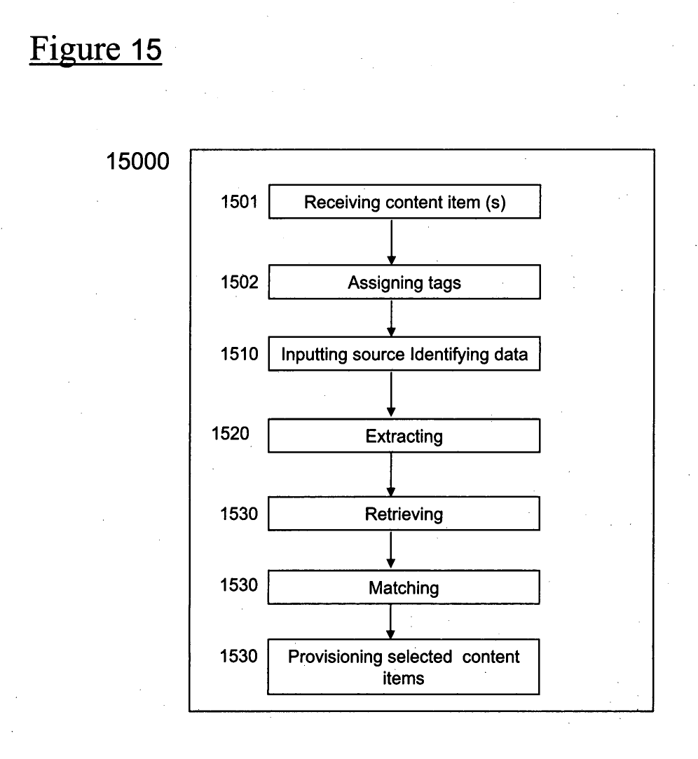

Reference is now made to FIG. 15 which is a flow chart illustrating a method for tagging and provisioning content in an intuitive-associative manner, according to a preferred embodiment of the present invention.

In a method according to a preferred embodiment of the present invention, one or more content item(s) is (are) received 1501 from a content provider, say by one of remote users of the apparatus 3100, as described in further detail hereinabove. Optionally, the content items are sent by the remote user through the Internet or through a cellular telephony network.

Next, one or more of the received content items is (are) dynamically assigned 1502 one or more tag(s), say by the content tag assigner 370, as described in further detail hereinabove.

Optionally, one or more of the tags is a rating tag. The rating tag may be based on the item's rating, say according to the number of times the specific item is provisioned to a user.

The tags may also indicate pricing data pertaining to the content item, say the price to the user, the cost of the content item (that is to say, the price charged by the content provider), the type of the content (say erotic), a time limitation, etc, as described in further detail hereinabove.

Next, there is received source identifying data 1500 from a user 1510, say by the above described data receiver 310. The source may be, but is not limited to, a broadcasting channel such as a TV channel or a radio channel, a narrow-casting channel such a video on demand (VOD) channel, an Internet channel, a P2P data channel, or any other source.

The source identifying data 1500 may be textual, for example—an SMS textual message such as: <MTV>, or non-textual, for example—a snap shot of a show being broadcasted on TV, where a channel logo may be found.

The source identifying data may be processed for extracting a source identifier 1520 from the source identifying data 1500, say by a source extractor 320, as discussed in greater detail hereinabove.

Next relevant items transmitted in the source at a time frame of the user input data are fetched.

In a preferred embodiment, one or more relevant item are retrieved 1530 from an updated list of items transmitted in the source (a play list), according to a time frame of the inputting of the source identifying data 1500. Optionally, the time frame may be extracted from a time stamp associated with the user provided source-identifying data.

The relevant items are then matched 1540 with one or more content item(s), as described in greater detail hereinabove. Preferably, the matching includes using the tags assigned to the content items.

Finally, one or more of the matched content items are selected and provisioned to the user 1550, as described hereinabove.

For example, a user may watch a clip on MTV, impulsively decide he wants it, though failing to identify the performer or song, send a SMS textual message: <MTV>, and eventually purchase one or more ringtones of songs that are performed by a performer of the clip.

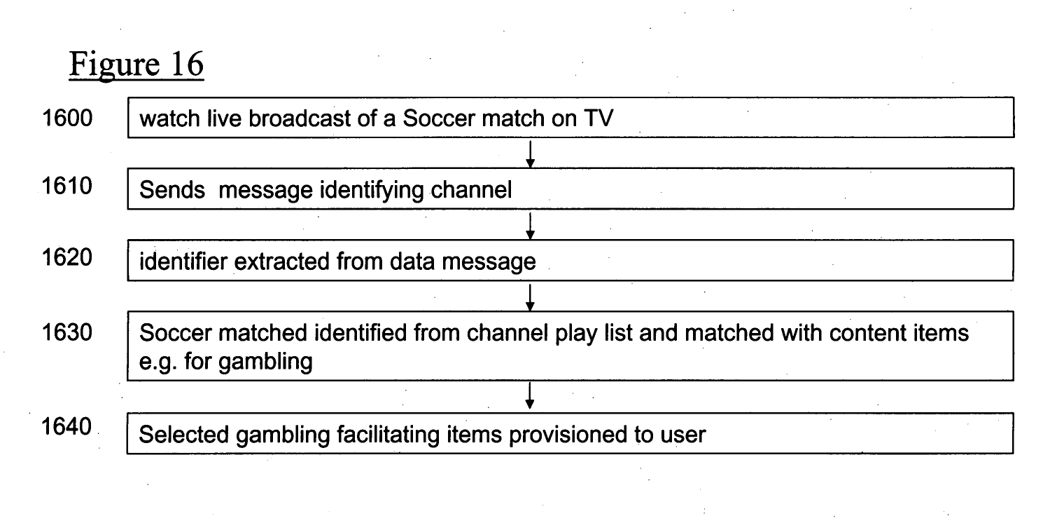

Reference now is made to FIG. 16 which is a flow chart illustrating an exemplary gambling scenario according to a preferred embodiment of the present invention.

For example, a user watches a live broadcast of a Soccer match on a TV source 1600. When a user sent data message 1610 identifying the TV channel is input by the data receiver 310, the source extractor 320 extracts the TV channel identifier from the data message 1620.

The matcher 330 retrieves 1630 the live broadcast match from the list of items transmitted in the channel (the TV channel play list), and matches the live broadcast match with content items facilitating a gambling service such as a link to a web page where the user may make a bet against another user or against the house, the house being an external content provider.

Selected items of the gambling content items (for example, web links) are then provisioned to the user 1640, thus facilitating his participation in the gambling.

There are many betting formulas that may be applied in such a scenario: the user may bet on a goal in the next few minutes, the user may bet on the final result of the match, the user may bet on who is going to score in the next few minutes, the user may vote on the most interesting minute in the match (to be determined by the voters), etc.

An apparatus according to a preferred embodiment of the present invention may also be used as a part of an interactive gambling platform. For example, a user may be asked to choose among various gambling schemes relating to a Soccer match he watches, say betting on match results vs. betting on performance of players. If the user chooses to bet on players he may be provided a list of players and bet on the player who scores the next goal, etc.

In another example, an apparatus according to a preferred embodiment of the present invention is used for downloading a computer game just played on a computer game zone or like TV channel.

In another example the apparatus according to a preferred embodiment of the present invention may facilitate participation in an auction running live on a TV channel, where a participator may send an SMS message when he wishes to buy the product presented on the channel at the currently bid price.

An apparatus according to a preferred embodiment of the present invention may be used for purchasing products as well as services, as described in hereinabove, say for purchasing a Golf club membership upon watching a program about Golf.

An apparatus according to a preferred embodiment of the present invention may also be used to interactively purchase video clips, video data etc. as described in greater detail hereinabove.

An apparatus according to a preferred embodiment of the present invention may also facilitate a scenario where music items played in a local source such as a music system run in a pub, connected to the apparatus, may be provisioned to a pub visitor who sends an SMS identifying the pub whose music system provides the music items.

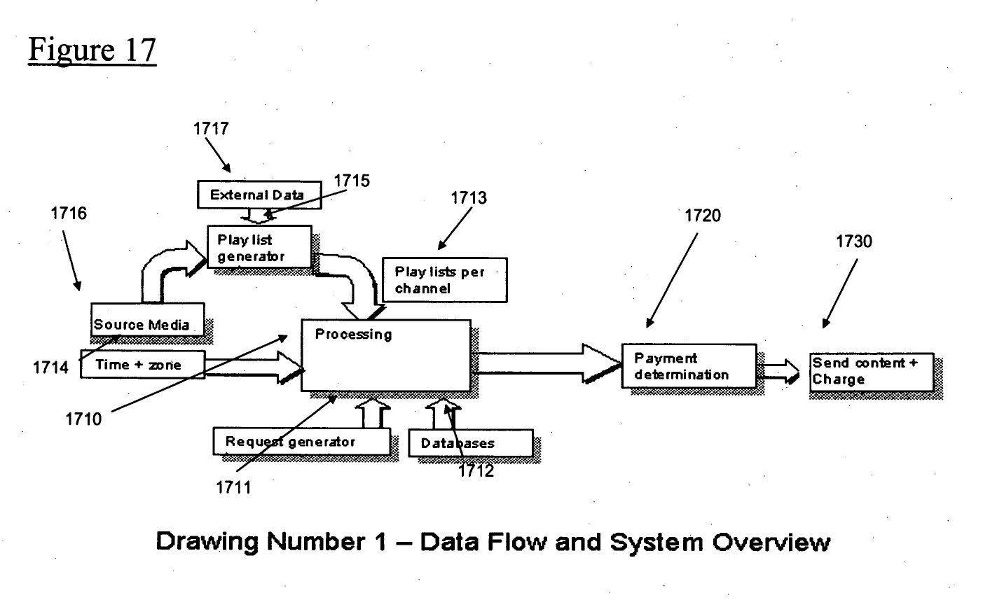

Reference is now made to FIG. 17 which is a flow chart illustrating a billing method according to a preferred embodiment of the present invention.

A billing method according to a preferred embodiment of the present invention is comprised of three main stages: processing a request 1710, payment determination 1720, and finally sending content items to the user and charging for the content items 1730.

As described in greater detail hereinabove, in the processing stage, the user sent source identifying data is used for extracting the source identifier, say using a request generator 1711.

The processing stage further uses database data 1712, as described hereinabove to retrieve relevant items from a source specific play list 1713, according to the time frame when the user sends his request and the geographical or time zone from where the request is sent 1714.

As described hereinabove, the source specific play list 1713 is assembled by a play list generator (assembler) 1715 which reads the various source media 1716 comprising of the items that are transmitted in the source as well as external data 1717.

The relevant items are matched with content items, say by a matcher unit 330 as described hereinabove, and one or more of the matched content items are selected for provisioning to the user.

In the payment determination 1720 stage, the billing tasks relating to the provisioned content items are carried out, say by a billing module as described hereinabove.

Finally, the user is provisioned with the content items and charged for the content items 1730, as determined in the payment determination stage.

The billing module may use billing relevant data such as the user ID, the name of the user, the address of the user, payment means, and charge the user using a variety of payment methods, including but not limited to: using the credit card of the user, using the bank account of the user, a reverse billing SMS where the owner of the recipient phone rather than the sender of the message is charged for the cost of the SMS, etc.

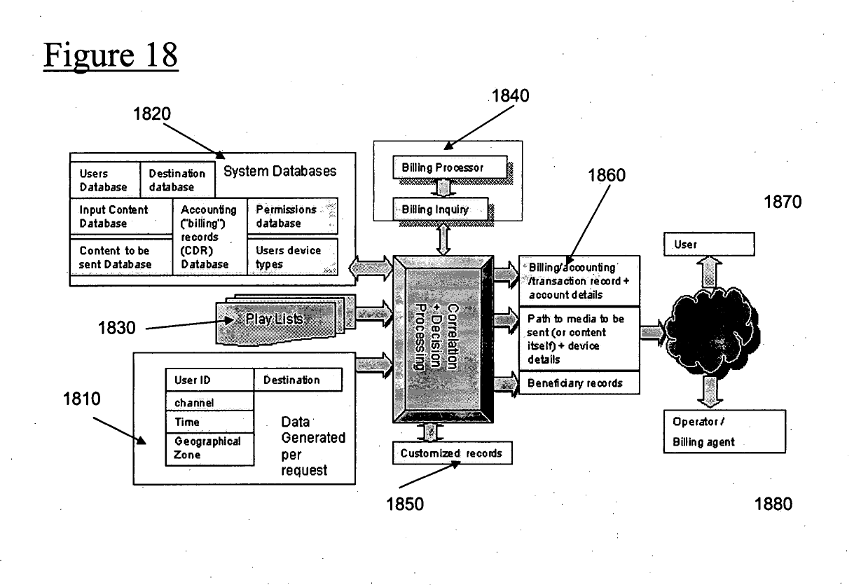

Reference is now made to FIG. 18 which is a detailed flow chart illustrating a billing method according to a preferred embodiment of the present invention.

A billing method according to a preferred embodiment of the present invention includes the following activities:
Receiving a user sent relevant data item 1810, including but not limited to:
   a User ID/details,
   the source,
   time of the request, which may also be determined at the receiving side,
   geographical data, for example, if a user inputs a MTV identifier, it may be possible to determine if the user is watching MTV Europe or MTV Asia based on his geographical location,
   a receiving device type,
   a payment method (as described hereinabove), etc.
processing the user sent data 1810 utilizing data residing in system databases 1820 and source play lists 1830, as described in greater detail above, for provisioning selected content items to the user.
sending a billing query to the billing processor/module 1840. The billing module 1840 may utilize billing customization records 1850, defining billing rules for the billing module to follow.
generating relevant records for billing 1860, accounting, provisioning of content items, and paying royalties to copyright holders of the provisioned content items, as described in greater detail hereinabove.
sending the relevant records to the user 1870 and to other sides 1880 which may include but are not limited to: content providers, service operators, billing agents (say, a bank), etc.

Table 1 provides several examples for implementing a method in accordance with preferred embodiment of the present invention.

TABLE 1

| | | | | Package to | |
|---|---|---|---|---|---|
| Source media | | Play list of source | The system may include | be sent, | |
| that triggers the | | media, Generated | DB created and | includes part | Form of |
| transaction | Request Generator | by | maintained | of, or at least | payment |
| Radio | Remote control | Automatic | Users | Content sold | Credit |
| | | recognition | (phone numbers, email | or a link/ | Card |
| | | | addresses, user names, | path to the | |
| | | | user Id, . . . ) | content | |
| TV | Mobile phone | A person | Paying identity + balance | Destination | Field |
| | | | | device | operator |
| PC | Fixed phone | A list given by the | Songs, other input | Destination | Mobile |
| | | media channel | content | type | operator |
| | | operator | | | |
| Internet event | SMS | A computer | Content to be sent: ring | Transaction | Prepaid |
| | | program | tones, ring back tones, | charge | card |
| | | | video clips, icons, games, | | |
| | | | etc. | | |
| Random selection | Internet | Other Data base | Accounting records | Beneficiary | |
| Selection per | PC | Data generated by a | Destinations phone | Transaction | |
| criteria (e.g. | | third party | numbers, Device type | code | |
| performer) | | | | | |
| Printed | WAP session | | | Customized | |
| Advertisement | | | | records | |
| Theatre/movie/ | Java program | | | | |
| live | | | | | |
| performance/sport | | | | | |
| event or play | | | | | |
| Transmitted | Brew program | | | | |
| Advertisement | | | | | |
| | DECT phone | | | | |
| | Other event | | | | |

The source transmitting a content item as described hereinabove, may belong to any of the following source types, or to any other source type:
Digital or Analog Terrestrial Radio broadcasting.
Digital or Analog Terrestrial TV broadcasting.
Cable TV broadcasting.
Satellite TV broadcasting.
Satellite radio broadcasting.
Internet radio broadcasting.
Internet video streaming.
Mobile phones video/audio streaming.
Mobile TV broadcasting.
IP based Video and Audio streaming.
Movie in a theatre, or to another limited size audience.
Football arena and other sport play grounds.
Narrowcasting of any audio, video or any other digital content or data.
Service oriented networks such as i-mode.

The user may send the channel identifying data using any known in the art device, including but not limited to:
Mobile phones
PDA
A personal computer
A TV set-top box
A TV remote control
A dedicated music and video players such as i-Pod
A gaming console such as a Sony Play station™ device.
Blackberry and the like.

The identifying data may be sent in any of the following data formats, or at any other data format:
SMS
MMS
E-mail
Picture Message
Picture of any type
Recordable sound
Recordable video text
Proprietary outgoing message by a device client
HTML request
URL (by web or wap)
IVR (such as DTMF)
By voice—directly through IVR or using a dial in service
In an audio format, attached to any of the above formats
By Interactive TV methods
Using Barcode
By handwriting

The channel transmitted item may belong to any one of the following types, or to any other type:
Song tracks
Song clips
TV shows
Sport games
Radio programs
News bulletins
Any other video/audio/picture item.

The content items that may be provisioned to the user may include but are not limited to the following types:
Ringtones for mobile phones, (e.g. monophonic, polyphonic, “true tone”/wave based/MP3/other audio, picture and video based)
Ringback tones for mobile phones
Audio digital tracks in all file types such as (but not limited to) MP3, ACC, WAV etc.
Video digital clips in any known in the art media types such as (but not limited to) MPEG, MPG, RM, AVI, WMV, MOV etc.
Digital pictures in known in the art media types such as (but not limited to) JPG, JPEG, Gif, BMP
Mobile phone icons in various formats
Mobile phone wallpapers
Mobile phone MMS clips and other video clips
PC Games
Console games
Internet downloadable games
Mobile phone games
Multi-player games
Associated information in various formats such as video, audio and text
Associated links in various formats such as Web links and WAP links
URLs
Text Documents (such as recipes, articles, gossips)
Digital books
Audio books
Movies
Coupons
One time passwords
Other passwords
Links to any of the above or below
Full or snipped content from the broadcasted media itself
Recommendations for additional content based on preferences or provisioning history of the user
Album, movies, content reviews
Links to media-related chat rooms,
Links to shared music lists.

The selected provisioned content item(s) may be received by the user, utilizing a receiving device, including but not limited to:
Mobile phones
PDA
Personal computers
TV set-top boxes
Dedicated Music and Video players such as iPod
Gaming consoles
Instant messenger—such as AIM (ICQ)™, Yahoo™, Microsoft™, etc.
Skype™ clients or similar IP telephony/video service clients

The provisioned content item(s) may be delivered to the user through any of the following and other methods, or a combination thereof:
E-mails (with or without attachments)
SMS
MMS
WAP links
URLS
Web links
Podcasting (downloading of audio broadcasts to iPod™) and the like
Media device client session (such as Java sessions)
FTP
Direct download
Download via a device client

Automatic Crawlers and Database Management Tools

A preferred embodiment of the present invention may employ any of the following crawlers and database management tools:
a tool which feeds a content catalog builder with new content items upon the updating of an existing content database with a new content item.
a tool which automatically feeds a content catalog builder with any new content item that is automatically generated by a content generator as described hereinabove.
a tool which merges content items/indexes database records received from a content provider into a content catalog and/or a content database.
a tool which synchronizes local databases with affiliate content provider or any other relevant business partner databases.
a tool which synchronizes multiple subsets of any of the databases described in the application, utilizing a full copy or a change based update mechanism.
a dedicated tool may be used to automatically extract content transmitted in a channel, split it, categorize it (music/talks/commercial/show/etc.) and index it using a local or an external database.
a dedicated tool may be used to extract identification data of a transmitted item using radio display system (RDS), or from the transmitted item itself.
a crawler may be connected to any public, internal, external, or other database for detecting new content and forwarding add it to a content catalog, using the content catalog builder as described above.
a tool which handles the synchronization of databases that are internal or external to the apparatus 3200.

Marketing Techniques

In a preferred embodiment, the apparatus 3200 may be used to implement a marketing technique, such as the following:
Multi level marketing—the user may be motivated, say by promising the user a commission, to forward advertisement links or any other provisioned content items to other users.
Word of link—promotional links that may be inserted into GUI pages sent to the user, insertion of promotional ringtones into GUI pages sent to the user
Cross marketing—insertion of services that are associatively linked with the content items that are presented to the user via the GUI pages.
White labeling—the apparatus 3200 may be used by another service, and the operators of the other service may inform their users that the other service is facilitated using the technology provided by the apparatus, thus exposing the service provided by the apparatus 3200 to new potential users.
Off line promotions—such as using a radio broadcast to publish the service. For example—send a SMS message to a specific number and receive a just played ringtone.

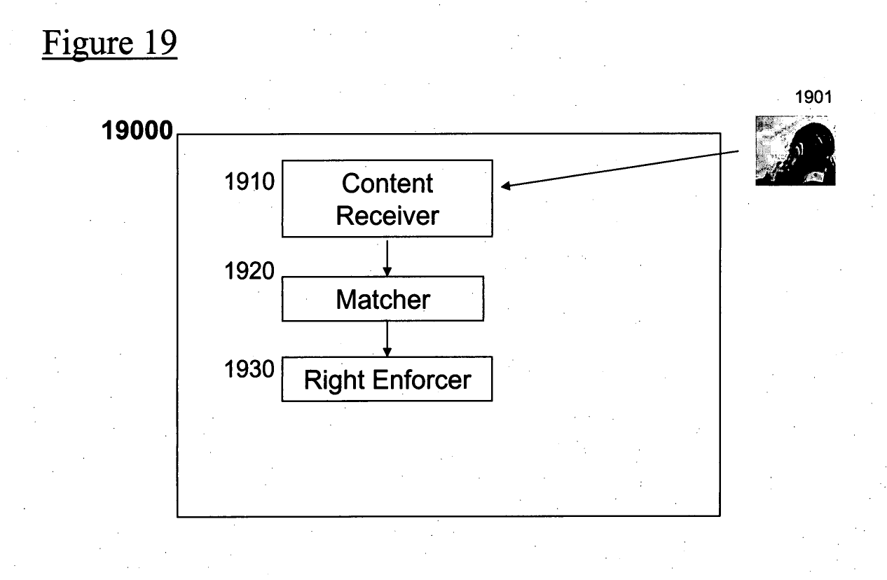

Reference is now made to FIG. 19, which is a block diagram illustrating an apparatus, for discovering and subsequently protecting rights in a content item, according to a preferred embodiment of the present invention.

Apparatus 19000 comprises a content receiver 1910, configured to receive the content item, say from a third generation (3G) cellular handset user 1901, as known in the art.

Apparatus 19000 also includes a matcher 1920, connected to the content receive 1910.

The matcher 1920 finds a match between the content item and one or more catalogued items, recorded in a catalog as having predefined rights. For example, a Madonna ringtone may be catalogued with copyrights belonging to Madonna, etc. The matcher 1920 may use fingerprint comparison, etc, as described for the matcher in further detail hereinabove.

The apparatus 19000 also includes a right enforcer 1930, connected to the matcher 1920.

The right enforcer 1930 performs a predefined action upon finding the match. For example, the right enforcer 1930 may block distribution of the content item received from the third generation (3G) cellular handset user 1901, once the content item is matched with a catalog item catalogued with copyrights belonging to Madonna.

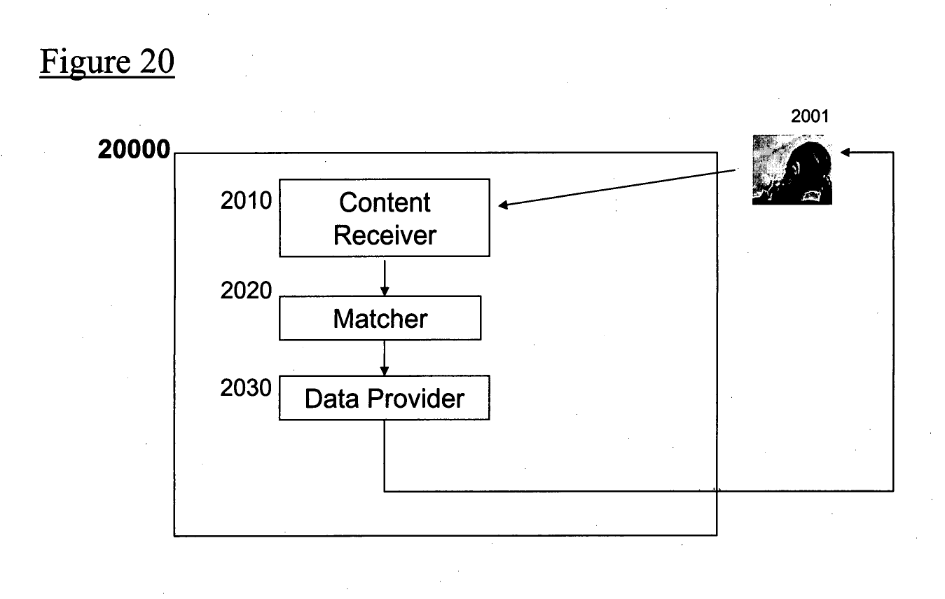

Reference is now made to FIG. 20, which is a block diagram illustrating an apparatus, for finding a source according to a content item transmitted therein, according to a preferred embodiment of the present invention.

Apparatus 20000 comprises a content receiver 2010, for receiving the content item from a user 2001.

The apparatus 20000 also includes a matcher 2020, connected to the content receiver 2010.

The matcher 2020 matches the content item with one or more relevant item(s). The relevant item are transmitted in a source such as a certain TV station, within a time frame of receiving the content item, say using fingerprint comparison, as described in further detail hereinabove.

Apparatus 20000 also includes a data provider 2030, connected to the matcher, 2020.

The data provider 2030 provides the user 2001 with data pertaining to the source, say by sending the user 201 an SMS message bearing the identity of the source (For example, an SMS bearing the word “MTV”), by sending the user 201 a link, usable for downloading a video stream (or an audio stream) of the live broadcast of the source, etc.

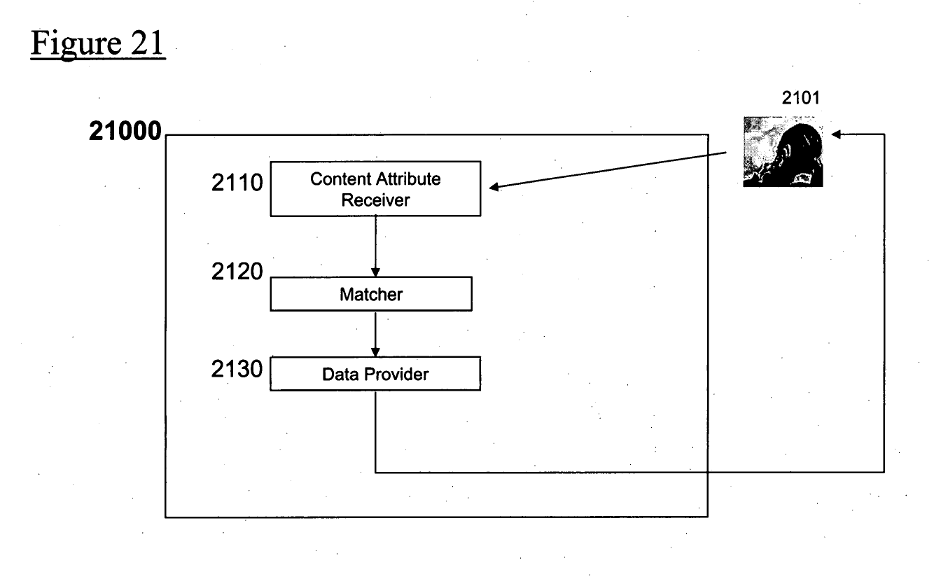

Reference is now made to FIG. 21, which is a block diagram illustrating a second apparatus that finds a source according to a content item transmitted therein, according to a preferred embodiment of the present invention.

Apparatus 2100 comprises a content attribute receiver 2110, for receiving a content attribute from a user 2101.

Apparatus 2100 also includes a matcher 2120, connected to the content attribute receiver 2110.

The matcher 2120 matches one or more content items with one or more relevant items, say using fingerprint comparison, as described in further detail hereinabove.

The relevant items are transmitted in a source within a time frame of receiving the content attribute, and the content items is pre-assigned an attribute similar to the content attribute.

For example, the content items may be video clips and ringtones pre-assigned with attributes such as “Madonna”, “Jazz”, etc. The relevant items may be Madonna Video clips shown in the MTV European TV Channel, a Jazz concert broadcast live on the BBC Radio Channel, etc.

Apparatus 21000 also includes a data provider 2130, connected to the matcher 2130, and configured to provide the user 2101 with data pertaining to the source, say as an SMS message bearing “BBC Radio”, or a link to a stream of the channel or broadcast as described in further detail hereinabove.

It is expected that during the life of this patent many relevant devices and systems will be developed and the scope of the terms herein, particularly of the terms “Internet”, “Cellular phone”, “PDA”, “Palm pilot” “SMS”, “Channel”, “Broadcasting”, “Narrowcasting”, “Content”, “Ringtone”, “Monotone”, “Polytone”, “Clip”, and “GUI”, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for tagging and provisioning user generated content in an intuitive-associative manner, comprising:
a content item receiver, configured to receive at least one user generated content item from a first user;
a content tag assigner, configured to assign at least one tag to at least one of said received content items;
a data receiver, configured to receive data identifying a transmission source from a second user;
a matcher, associated with said data receiver, configured to match at least one relevant item transmitted in the source at a time frame of said receiving with at least one of said user generated content items; and
a provisioner, associated with said matcher, for provisioning a selected one of said user generated content items to the second user.

2. The apparatus of claim 1, wherein said content tag assigner, is further configured to dynamically assign said tag.

3. Apparatus for tagging and provisioning content in an intuitive-associative manner, comprising:
a content item receiver, configured to receive at least one content item from a content provider;
a content tag assigner, configured to assign at least one tag to at least one of said received content items;
a data receiver, configured to receive data identifying a transmission source from a user;
a matcher, associated with said data receiver, configured to match at least one relevant item transmitted in the source at a time frame of said receiving with at least one of said content items; and
a provisioner, associated with said matcher, for provisioning selected content items of said content items to the user.

4. The apparatus of claim 3, wherein said content tag assigner, is further configured to dynamically assign said tag.

5. The apparatus of claim 3, wherein said content provider is a remote user, and said item content is generated by said content provider.

6. The apparatus of claim 3, wherein said matcher is further configured to use said tags for said matching.

7. The apparatus of claim 3, wherein said provisioner is further configured to present said tags assigned to said selected content items to the user.

8. The apparatus of claim 3, wherein said content tag assigner is further configured to dynamically assign at least one of said tags substantially simultaneously to said provisioning.

9. The apparatus of claim 3, wherein one of said tags is a rating tag providing rating for said content item.

10. The apparatus of claim 3, wherein one of said tags is a rating tag providing rating for said content provider.

11. The apparatus of claim 3, wherein said content tag assigner is further configured to use rating data provided by the user, for said assigning said tag.

12. The apparatus of claim 3, wherein said provisioner is further configured to receive rating data from the user, and said content tag assigner is further configured to use said rating data, for said assigning said tag.

13. The apparatus of claim 3, wherein said provisioner is further configured to receive rating data from the user, and said content tag assigner is further configured to use said rating data, for said assigning said tag, said rating data being received through a cellular telephone Graphical user interface (GUI).

14. The apparatus of claim 3, wherein said provisioner is further configured to receive rating data from the user as a Short Message Service (SMS) message, and said content tag assigner is further configured to use said rating data, for said assigning said tag.

15. The apparatus of claim 3, wherein said content tag assigner is further configured to use historic rating data, for said assigning said tag, said historic rating data comprising rating data provided by the user for a plurality of content items.

16. The apparatus of claim 3, wherein said content tag assigner is further configured to use data provided by an operator of the apparatus, for said assigning said tag.

17. The apparatus of claim 3, wherein said content tag assigner is further configured to use rating data provided by an operator of the apparatus, for said assigning said tag.

18. The apparatus of claim 3, wherein said content tag assigner is further configured to use data pertaining to a real time event, for said assigning said tag.

19. The apparatus of claim 3, wherein said content tag assigner is further configured to use history data pertaining to provisioning history of said content item, for said assigning said tag.

20. The apparatus of claim 3, further comprising a content blocker, operable for blocking a content item, wherein said provisioner is further configured to avoid provisioning said blocked content item.

21. The apparatus of claim 3, further comprising a management unit, associated with said content item receiver, and configured to edit said received content item.

22. The apparatus of claim 3, wherein said content item receiver is further configured to receive said content item through a web site.

23. The apparatus of claim 3, wherein said content item receiver is further configured to receive said content item through an agent installed at premises of said content provider.

24. The apparatus of claim 3, further comprising an event manager, associated with the matcher, and operable for defining at least one event, wherein said content tag assigner is operable to assign a tag pertaining to said event to the content item, and said matcher is further configured to match said content item with said relevant item transmitted in the source, upon occurrence of said event.

25. The apparatus of claim 3, further comprising a rating module, configured to generate rating data for at least one of a group comprising: said content item, said content provider, and said user.

26. The apparatus of claim 3, further comprising a rating module, configured to generate rating data for said content item.

27. The apparatus of claim 3, further comprising an extractor, associated with said data receiver, for extracting an identity of said source from said data.

28. The apparatus of claim 3, wherein said received content item is a user generated content item.

29. The apparatus of claim 3, wherein said provisioner is further configured to provision a content item as a link usable for downloading a stream of a radio broadcast.

30. The apparatus of claim 3, wherein said provisioner is further configured to provision a content item as a link usable for downloading a stream of a television broadcast.

31. The apparatus of claim 3, wherein said provisioner is further configured to provision a content item as a message informing the user about a future event.

32. The apparatus of claim 3, wherein said source is a broadcasting channel.

33. The apparatus of claim 3, wherein said source is a narrowcasting channel.

34. The apparatus of claim 3, wherein said matcher is further configured to retrieve said relevant items from a list of items transmitted in the source.

35. The apparatus of claim 34, further comprising an assembler, for dynamically assembling said list of items transmitted in the source over said time frame.

36. The apparatus of claim 35, wherein said assembler comprises:
a source item reader, for reading an item being transmitted in said source;
an item identifier, associated with said source item reader, for identifying said transmitted item; and
a list updater, associated with said item identifier, for updating said list of items with identification data of said identified transmitted item and a respective time frame of transmission of said identified transmitted item.

37. The apparatus of claim 36, wherein said item identifier is further configured to compare a fingerprint extracted from said read item with at least one identifying fingerprint residing in a content catalog, each of said identifying fingerprints relating to a respective content item.

38. The apparatus of claim 36, wherein said item identifier is further configured to use data pertaining to a location of a fingerprint within an item, for carrying out said identifying.

39. The apparatus of claim 35, wherein said assembler further comprises a statistics generator, configured to dynamically generate statistics relating to items transmitted in said source.

40. The apparatus of claim 36, wherein said item identifier is further configured to use one of a group comprising: statistics relating to items transmitted in said source, general statistics relating to transmitted items, and statistics relating to preferences according to a geographic region of said source.

41. The apparatus of claim 3, further comprising a content catalog builder, for building a content catalog, said content catalog builder comprising:
an item receiver, for receiving a content item,
an identification receiver, for receiving identification data of said content item,
a fingerprint extractor, for extracting an identifying fingerprint from said content item, and
a content updater, for updating the content catalog with said identifying fingerprint and with said identification data.

42. The apparatus of claim 41, wherein said content catalog builder further includes a remote content updater, operable for remotely updating the content catalog with an identifying fingerprint pointing to a remotely stored content item.

43. The apparatus of claim 41, wherein said content catalog builder further includes a remote content updater, operable for remotely updating the content catalog with identification data relating to a remotely stored content item.

44. The apparatus of claim 41, wherein said content updater is further configured to update the content catalog with data pertaining to a location of said fingerprint within said content item.

45. The apparatus of claim 3, wherein said provisioner is further configured to present said content items to said user in a dynamically configurable interactive graphical user interface (GUI).

46. The apparatus of claim 3, wherein said provisioner is further configured to present said content items to said user in a dynamically configurable interactive graphical user interface (GUI), wherein said provisioner is further configured to present said content items in an order dependent on said tags.

47. The apparatus of claim 3, wherein said provisioner is further configured to present said content items to said user by a multi paged graphical interaction with said user.

48. The apparatus of claim 3, wherein said provisioner is further configured to select at least one of said content items for provisioning to said user, according to at least one of a group comprised of: a predefined preference with respect to said content items, information relating to the user, information relating to content items, provisioning history data, capabilities of a receiving device used by said user, geographic data, demographic data, socio-economical data, user made selections, and said tags.

49. The apparatus of claim 3, wherein said data identifying said source comprises non-textual data.

50. The apparatus of claim 27, wherein said extractor is configured to utilize at least one of a group comprising: optical character recognition (OCR), image processing, and spelling correction, for extracting said identity of said source from said data.

51. The apparatus of claim 3, further comprising a content generator, for generating a new content item from an existing content item.

52. The apparatus of claim 3, further comprising a history recorder, associated with said provisioner, configured to record history data relating to content provisioning to said user.

53. The apparatus of claim 52, wherein said history recorder is further configured to record back-up data pertaining to said provisioned content items, so as to allow future use of said provisioned items by said user.

54. The apparatus of claim 3, further comprising a format converter, associated with said provisioner, configured to convert a content item into a format usable by a receiving device used by said user.

55. The apparatus of claim 3, further comprising a correlation data generator, associated with said provisioner, configured to generate correlation data pertaining to correlation between transmission of an item in a source and provisioning of a respective content item to a user.

56. The apparatus of claim 55, wherein said correlation data comprises at least one of a group comprising: user characterizing data, source data, time of provisioning, type of content item, geographic data, demographic data, socio-economic data, and said tags assigned to said transmitted item.

57. The apparatus of claim 3, wherein said selected content items of said content items are provisioned to the user as web links.

58. Method for tagging and provisioning content in an intuitive-associative manner, comprising:
receiving at least one content item from a content provider;
assigning at least one tag to at least one of said received content items;
receiving data identifying a transmission source from a user;
matching at least one relevant item transmitted in the source at a time frame of said receiving with at least one of said content items; and
provisioning selected content items of said content items to the user.

59. The method of claim 58, wherein said assigning in carried out in a dynamic manner.

60. The method of claim 58, wherein said matching is carried out using said tags.

61. The method of claim 58, wherein said provisioning is carried out using said tags.

62. The method of claim 58, further comprising presenting said tags assigned to said selected content items to the user.

63. The method of claim 58, wherein said assigning said tag is carried out substantially simultaneously to said provisioning.

64. The method of claim 58, wherein one of said tags is a rating tag providing rating for said content item.

65. The method of claim 58, wherein one of said tags is a rating tag providing rating for said content provider.

66. The method of claim 58, wherein said assigning said tag includes using rating data provided by the user.

67. The method of claim 58, wherein said assigning said tag includes using rating data provided by the user for a plurality of content items.

68. The method of claim 58, wherein said assigning said tag includes using data provided by an operator of an apparatus implementing the method.

69. The method of claim 58, wherein said assigning said tag includes using data pertaining to a real time event.

70. The method of claim 58, wherein said assigning said tag includes using history data pertaining to provisioning history of said content item.

71. The method of claim 58, further comprising blocking a content item, so as to avoid provisioning said blocked content item.

72. The method of claim 58, further comprising editing said received content item.

73. The method of claim 58, wherein said receiving said content item is carried out through a web site.

74. The method of claim 58, wherein said receiving said content item is carried out through an agent installed at premises of said content provider.

75. The method of claim 60, wherein said content provider is a remote user, and said content item is generated by said content provider.

76. The method of claim 58, further comprising provisioning a content item as a link usable for downloading a stream of a radio broadcast.

77. The method of claim 58, further comprising provisioning a content item as a link usable for downloading a stream of a television broadcast.

78. The method of claim 58, further comprising provisioning a content item as a message informing the user about a future event.

79. The method of claim 58, further comprising extracting an identity of said source from said data.

80. The method of claim 58, wherein said matching includes said relevant items from a list of items transmitted in the source.

81. The method of claim 80, further comprising dynamically assembling said list of items, said assembling comprising:
reading an item being transmitted in said source,
identifying said transmitted item, and
adding identification data of said identified transmitted item and a respective time frame of transmission of said identified transmitted item to said list of items.

82. The method of claim 81, wherein said identifying further includes a comparison of a fingerprint extracted from said read item with at least one identifying fingerprint residing in a content catalog, each of said identifying fingerprints relating to a respective content item.

83. The method of claim 82, wherein said comparison further includes using data pertaining to a location of a fingerprint within an item.

84. The method of claim 81, further comprising dynamically generating statistics relating to items transmitted in said source.

85. The method of claim 81, wherein said identifying is carried out using one of a group comprising: statistics relating to items transmitted in said source, general statistics relating to transmitted items, and statistics relating to preferences according to a geographic region of said source.

86. The method of claim 58, further comprising updating a content catalog, said updating comprising:
receiving a content item,
receiving identification data of said content item,
extracting an identifying fingerprint from said content item, and
updating said content catalog with said identifying fingerprint and with said identification data.

87. The method of claim 86, further comprising updating said content catalog with data pertaining to a location of said fingerprint within said content item.

88. The method of claim 58, wherein said provisioning further includes presenting said content items to said user in a dynamically configurable interactive graphical user interface (GUI).

89. The method of claim 58, wherein said provisioning comprises a multi paged graphical interaction with said user.

90. The method of claim 58, wherein said provisioning comprises selecting at least one of said content items for provisioning to said user, according to at least one of a group comprised of: a predefined preference with respect to said content items, information relating to said user, information relating to content items, provisioning history data, capabilities of a receiving device used by said user, geographic data, demographic data, socio-economical data, said tags, and user made selections.

91. The method of claim 58, wherein said data identifying said source comprises non-textual data.

92. The method of claim 79, wherein said extracting an identifier of said source from the identifying data is carried out utilizing at least one of a group comprising: optical character recognition (OCR), image processing, and spelling correction.

93. The method of claim 58, further comprising generating a new content item from an existing content item.

94. The method of claim 58, further comprising recording history data relating to content provisioning to said user.

95. The method of claim 58, further comprising recording back-up data pertaining to said selected content items, for future use by said user.

96. The method of claim 58, wherein said provisioning further comprises converting a content item into a format usable by a receiving device used by said user.

97. The method of claim 58, further comprising generating correlation data pertaining to correlation between transmission of an item in a source and provisioning of a respective content item to a user.

98. The method of claim 97, wherein said correlation data further includes at least one of a group comprising: user characterizing data, source data, time of provisioning, type of content item, geographic data, demographic data, socio-economic data, and said tags.

99. The method of claim 58, wherein said selected items of said content items are provisioned to the user as web links.

100. Apparatus for provisioning tagged content in an intuitive-associative manner, comprising:
a data receiver, for receiving a user message;
a provisioner, associated with said data receiver, for provisioning a content item to a user, according to said user message and at least one tag pre-assigned to said content item;
a matcher, associated with said provisioner, for matching said provisioned content item with a relevant item from at least one item transmitted in a respective source, said matching being carried out according to a time frame of said user message and relevance of said transmitted item to said provisioned content item; and
a correlation data generator, associated with said matcher, for generating data pertaining to correlation between said relevant item and said provisioned item.

101. The apparatus of claim 100, wherein said matcher is further configured to retrieve said relevant item from a list of items transmitted in said source.

102. The apparatus of claim 3, wherein said provisioner is further configured to facilitate gambling, utilizing said selected content items.

103. Apparatus for finding rights in a content item, comprising:
a content receiver, configured to receive the content item;
a matcher, associated with said content receiver, configured to find a match between the content item and at least one catalogued item having predefined rights recorded in a catalogue; and
a right enforcer, associated with said matcher, and configured to perform a predefined action upon finding said match.

104. The apparatus of claim 103, wherein said content receiver is a remote user.

105. The apparatus of claim 103, wherein said matcher is further configured to use fingerprint comparison, for said finding a match.

106. Apparatus for finding a source according to a content item transmitted therein, the apparatus comprising:
a content receiver, configured to receive the content item from a user;
a matcher, associated with said content receiver, configured to match said content item with at least one relevant item, wherein said relevant item is a transmitted item transmitted in a source within a time frame of said receiving said content item; and
a data provider, associated with said matcher, and configured to provide the user with data pertaining to said source.

107. The apparatus of claim 106, wherein said data pertaining to said source comprises a link usable for downloading a stream of a live broadcast of said source.

108. Apparatus for finding a source according to a content item transmitted therein, the apparatus comprising:
a content attribute receiver, configured to receive a content attribute from a user;
a matcher, associated with said content attribute receiver, configured to match at least one content item with at least one relevant item, wherein said relevant item is transmitted in a source within a time frame of said receiving said content attribute, and said content item is pre-assigned an attribute similar to said content attribute; and
a data provider, associated with said matcher, and configured to provide the user with data pertaining to said source.

109. The apparatus of claim 108, wherein said data pertaining to said source comprises a link usable for downloading a stream of a live broadcast of said source.

110. Apparatus for tagging and provisioning content in an intuitive-associative manner, comprising:
a content tag assigner, configured to assign at least one tag to at least one content item;
a data receiver, configured to receive data identifying a transmission source from a user;
a matcher, associated with said data receiver, configured to match at least one relevant item transmitted in the source at a time frame of said receiving with at least one of said content items; and
a provisioner, associated with said matcher, for provisioning selected content items of said content items to the user.

111. The apparatus of claim 110, wherein said content tag assigner, is further configured to dynamically assign said tag.
